(19) United States
(12) Patent Application Publication
(10) Pub. No.: US 2026/0197670 A1
(43) Pub. Date: Jul. 9, 2026

(54) APPARATUS AND METHODS FOR GENERATING AND DISTRIBUTING ENHANCED RULES DATA IN WIRELESS NETWORKS

(71) Applicant: Charter Communications Operating, LLC, St. Louis, MO (US)

(72) Inventors: Yildirim Sahin, Englewood, CO (US); Paul L. Russell, JR., Lawrence, NJ (US)

(21) Appl. No.: 19/243,530

(22) Filed: Jun. 19, 2025

Related U.S. Application Data
(60) Provisional application No. 63/742,793, filed on Jan. 7, 2025.

(51) Int. Cl. H04W 16/28; H04W 48/16

(52) U.S. Cl. CPC H04W 16/28; H04W 48/16

(57) ABSTRACT

Apparatus and methods for controlling data traffic steering within a wireless network. In one embodiment, the apparatus and methods provide enhanced traffic steering aspects of Multi Access (MA) Packet Data Unit (PDU) Session Establishment signaling flow. In one variant, an enhanced Policy and Charging Control (PCC) framework is utilized by a network process/entity, which allows the network process/entity to derive one or more enhanced traffic steering (Access Traffic Steering, Switching, and Splitting (ATSSS) and/or N4) rule frameworks based on the importance associated with a PDU set. In another variant, the one or more enhanced traffic steering (Access Traffic Steering, Switching, and Splitting (ATSSS) and/or N4) rule frameworks are used for dynamic control of steering functionality, including between 3GPP and non-3GPP network accesses for the data traffic.

### PRIORITY APPLICATION

This application claims the benefit of priority to U.S. Patent Provisional Application No. 63/742,793, filed Jan. 7, 2025, and entitled “Apparatus and Methods for Generating and Distributing Enhanced Rules Data in Wireless Networks,” which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Technological Field

The present disclosure relates generally to the field of wireless devices and networks thereof, and specifically in one exemplary aspect to enhanced specification and distribution of policies or rules relating to multi-access (MA) Packet Data Unit (PDU) Session Establishment signaling flow within in a radio network.

### 2. Description of Related Technology

Release 20 is part of the ongoing 3rd Generation Partnership Project (3GPP) standardization efforts for 5G and beyond, building on the capabilities introduced in earlier releases such as Release 15 (initial 5G), 5G enhancements in Release 16 and Release 17, introduction of 5G advanced features like artificial intelligence, extended reality in Release 18 and Release 19, which are called 5G-Advanced. Release 20 is anticipated to further enhance 5G-Advanced and lay the groundwork for the evolution to 6G. FIG. 1 illustrates the 3GPP 5GS (5G System) architecture 100 at a high level, including various interfaces between elements of the architecture.

One potential key focus area of Release 20 is Extended Reality (XR) and Interactive Media Services that the term “XRM services” is used for simplicity throughout the present disclosure. Release 20 may enhance support for augmented reality (AR), virtual reality (VR), and mixed reality (MR) applications, ensuring high-quality immersive experiences with reduced motion-to-photon latency.

Policy Functions, PDU Set Importance, and XRM Services-3GPP Release-16 introduced a “steering functionality,” namely the Access Traffic Steering, Switching, and Splitting (ATSSS) function, which enables an ATSSS-capable UE to steer, switch and split Multi-Access (MA) PDU session traffic across a 3GPP access 202 and a non-3GPP access 204 (see FIG. 2A, which is from 3GPP TS 23.501 V19.1.0 clauses 4.2.10). The rules governing ATSSS operation are sent from the Policy Control Function (PCF) 102 (FIG. 1) to the Session Management Function (SMF) 106, and from the SMF to UE 104 during Multi-Access (MA) Protocol Data Unit (PDU) operation. ATSSS rules contain a list of prioritized rules; each ATSSS rule consists of a Rule Precedence, and one or more Traffic Descriptors associated with Access Selection Descriptors. The Access Selection Descriptor contains mandatory steering mode information (e.g. Active-Standby, Smallest Delay, Load-Balancing, or Priority-Based), and optional Steering Functionality information (e.g., Multipath TCP (MPTCP), Multipath QUIC (MPQUIC), or ATSSS-LL). See FIG. 2 herein, which illustrates ATSSS information elements and structure, from Table 5.32.8-1 specified in 3GPP TS 23.501 V19.1.0. entitled “3rd Generation Partnership Project; Technical Specification Group Service and System Aspects; System Architecture for 5G System (5GS); Stage 2 (Release 19)” dated September 2024, which is incorporated herein by reference in its entirety. ATSSS rules for a given PDU session may be updated during the lifetime of the session; see 3GPP TS 23.501. In Release-19, MPQUIC-IP and MPQUIC-E have been introduced as new Steering Functionalities and in Release-18 MPQUIC refers to MPQUIC-UDP.

3GPP Release 18 introduced how 5GS functions support high data rate low latency services, extended Reality (XR) and Interactive Media Services (specified in TS 23.501 clause 5.37) and was further enhanced in Release 19. Throughout the present disclosure, the term “XRM services” is used for simplicity. One enhancement is the 5GS support for PDU Set based QoS handling including PDU Set identification and marking. A PDU Set is comprised of one or more PDUs carrying an application layer payload such as a video frame or video slice. The PDU Set based QoS handling by the NG-RAN is determined by PDU Set QoS Parameters in the QoS profile of the QoS Flow (specified in TS 23.501 clause 5.7.7) and PDU Set Information (PSI) provided by the PSA UPF via N3/N9 interface (as described in TS 23.501 clause 5.37.5.2).

FIG. 3 shows respective RTP header extensions (HEs) for one-byte and two-byte for PDU set marking (as described in 3GPP TS 26.522 clause 4.2). PDU Set marking can be performed by an RTP sender, such as an Application Server (e.g., MRF), a sender UE that sends media to an RTP receiver, such as a UE, or other 5G network components. Endpoints that support the RTP HE for PDU Set marking shall support both RTP HE formats (i.e., the one-byte and the two-byte formats) according to IETF RFC 8285.

If the RTP HE for PDU Set marking is the only RTP HE used, the endpoints shall use the 1-byte header format. If other 2-byte RTP HE elements are used in the same RTP stream, then the 2-byte header shall be used, unless the “a=extmap-allow-mixed” is successfully negotiated through SDP offer/answer, as described by RFC 8285. Included in each PDU Set is the PDU Set Importance (PSI) field.

In extant systems, the PDU Set Importance (PSI) field is generally utilized whenever the RAN needs to discard packets (e.g., under congestion situations), as described in 3GPP TS 26.522 clause 4.2.6.2. Specifically, 3GPP TS 26.522 clause 4.2.6.2 discloses that it is better to discard packets of lower importance rather than discarding packets randomly. If a discarded packet is critical for the media stream, the QoE may be severely degraded. For this reason, the PDU Set Importance (PSI) field can be used to mark PDU Sets with their importance level. The PSI field can then be used by the RAN to discard PDU sets. In case of congestion, PDU Sets with higher PSI values are more likely to be discarded.

Furthermore, 3GPP TS 38.415 clause 6.5.3.9 defines that PSI indicates the importance of the current PDU Set compared to other PDU Sets within the same QoS flow. Lower values shall indicate a higher importance. PDU Set with the highest importance PDU Set is indicated by 0 and the lowest importance PDU Set is indicated by 15.

3GPP Release 19 specifies non-3GPP access support for XRM services, such as PDU Set handling. Specifically, 3GPP Release 19 specifies, inter alia, the following:
N3IWF/TNGF/W-AGF in addition to PDU QoS parameters, uses the PDU Set QoS parameter(s) sent by SMF over N2 to determine IPSec Child SAs and W-UP resources; and
Uses PDU Set Information received in the GTP-U header over N3 to identify PDU Sets.
Dedicated 5G QoS Flow(s) and non-3GPP access resources (e.g. IPsec Child SAs) are used for carrying L4S enabled IP traffic.
ECN marking for L4S is supported in N3IWF, TNGF and W-AGF. It is controlled via N2 signaling (Indication of ECN marking for L4S for a corresponding QoS Flow(s)) and applies to proper mapping between L4S-enabled QoS profile(s) and L4S-enabled IPSec Child SAs or L4S-enabled W-UP resource(s).
ECN marking for L4S is supported in 5G-RG in UL. It is controlled via N1 signaling (Indication of ECN marking for L4S for a corresponding QoS Flow(s)) and applies to proper mapping between L4S-enabled QoS rule(s) and LAS-enabled W-UP resource(s).

### Unaddressed ATSSS for XRM Services Issues—

Currently, the 3GPP specifications, including Release 19, do not provide any data regarding how XRM services can leverage ATSSS features. Similarly, for the extant ATSSS rule framework described above, Release 19 ATSSS features do not leverage PDU Set Information, such as PDU Set Importance which identifies the relative importance of a PDU Set compared to other PDU Sets within a QoS Flow. Furthermore, the existing 3GPP mechanisms do not describe a criteria to select the appropriate steering function and steering mode to transfer a Multi-Access (MA) PDU session. Extant mechanisms can result in many inefficiencies—in particular, with respect to a user's quality of experience (QoE); for example, missing frames, jitter, and increased latency—as PDU sets are treated the same way.

Accordingly, there exists a need for improved methods and apparatus to, among other things, enhance existing rule frameworks to include mechanisms for leveraging the PDU Set Importance information such that, e.g., ATSSS features are enabled for, e.g., XRM services, and thus enable the transfer of a MA PDU session to an appropriate access network (3GPP or non-3GPP).

### SUMMARY

The present disclosure addresses the foregoing needs by providing, inter alia, methods and apparatus for enhancing rules data with packet data unit (PDU) Set Importance data to determine an appropriate steering feature (e.g., function and/or mode), such as for example those supported by a 3GPP 5G NR and non-3GPP protocols.

In one aspect of the disclosure, a method for utilizing enhanced rules data to leverage one or more steering features. In one embodiment, the method includes: obtaining a first data structure, the first data structure including a parameter relating to an importance associated with a plurality of packet data units (PDUs); based on at least a portion of the first data structure, determining at least one second data structure, the at least one second data structure including one or more steering rules with the parameter relating to the importance associated with the plurality of PDUs (i.e., PDU Set Importance); and distributing the at least one second data structure to one or more computerized devices, thereby enabling the one or more computerized devices to control one or more steering features in accordance with the one or more steering rules with the parameter relating to the importance associated with the plurality of PDUs.

In one variant, the method further includes receiving support data from the computerize device, the support data indicating that the one or more computerized devices support enhancement of the one or more steering rules with the importance associated with the plurality of PDUs.

In one implementation, the receiving of the support data includes a session management function (SMF) receiving, from the one or more computerized devices, support data in PDU Session Establishment Request or Modification signaling, the support data indicating the one or more computerized devices support at least one Access Traffic Steering, Switching and Splitting (ATSSS) rules data structure including the one or more steering rules with the parameter relating to the importance associated with the plurality of PDUs; the distributing of the at least one second data structure to one or more computerized devices includes distributing the at least one ATSSS rules data structure to only ones of the one or more computerized devices which support enhancement of the one or more steering rules with the importance associated with the plurality of PDUs based on the support data; and the one or more computerized devices include at least one of (i) a user equipment (UE) or (ii) a Fifth Generation Residential Gateway (5G-RG).

In another implementation, the receiving of the support data includes a session management function (SMF) receiving, from the one or more computerized devices, support data in at least one of (i) N4/PFCP Association Setup signaling or (ii) N4/PFCP Association Update signaling, the support data indicating the one or more computerized devices support at least one N4 rules data structure including the one or more steering rules with the parameter relating to the importance associated with the plurality of PDUs; the distributing of the at least one second data structure to one or more computerized devices includes distributing the at least one N4 rules data structure to only ones of the one or more computerized devices which support enhancement of the one or more steering rules with the importance associated with the plurality of PDUs based on the support data; and the one or more computerized devices include one or more User Plane Functions (UPFs).

In one variant, the method further includes receiving data representative of a request for establishment of a multi access (MA) PDU session.

In yet another variant, the obtaining of the first data structure includes a session management function (SMF) receiving, from a Policy Control Function (PCF), Policy and Charging Control (PCC) data having the parameter relating to the importance associated with the plurality of PDUs as part of one or more traffic descriptors.

In one implementation, the determining of the at least one second data structure includes generating, from the PCC data having the parameter relating to the importance associated with the plurality of PDUs as part of the one or more traffic descriptors, at least one of (i) an Access Traffic Steering, Switching and Splitting (ATSSS) rules data structure, or (ii) an N4 rules data structure, having the one or more steering rules with the parameter relating to the importance associated with the plurality of PDUs included therein.

In one configuration of the foregoing, the generating of the at least one of (i) the Access Traffic Steering, Switching and Splitting (ATSSS) rules data structure, or (ii) the N4 rules data structure includes generating at least one N4 rules data structure; and the distributing of the at least one second data structure to one or more computerized devices includes transmitting the at least one N4 rules data structure to at least one User Plane Function (UPF) for controlling traffic steering, switching and splitting in a downlink direction.

In another configuration, the generating of the at least one of (i) the Access Traffic Steering, Switching and Splitting (ATSSS) rules data structure, or (ii) the N4 rules data structure includes generating at least one ATSSS rules data structure; and the distributing of the at least one second data structure to one or more computerized devices includes transmitting the at least one ATSSS rules data structure to at least one of (a) a user equipment (UE) or (b) a Fifth Generation Residential Gateway (5G-RG) for controlling traffic steering, switching and splitting in an uplink direction.

Further, the transmitting of the at least one ATSSS rules data structure may include transmitting data representative of a PDU Session Establishment Accept message having the at least one ATSSS rules data structure included therein.

In another aspect of the disclosure, a computerized network apparatus for use within a content distribution network is disclosed. In one embodiment, the computerized network apparatus includes: digital processing apparatus; at least one network interface in data communication with the digital processing apparatus; and a storage device in data communication with the digital processing apparatus, wherein the storage device includes a storage medium having at least one computer program stored thereon.

In one variant, the at least one computer program is implemented to, when executed on the digital processing apparatus, cause the computerized network apparatus to: receive data relating to a request for establishment of a packet data unit (PDU) session; cause evaluation of at least the data relating to the request for establishment of the PDU session to obtain a data structure with an importance value or range; and determine, from the data structure with the importance value or range, one or more rules relating to one or more steering functionalities of at least one of (i) a User Plane Function (UPF), or (ii) a computerized client device.

In one implementation, the causation of the evaluation of at least the data relating to the request for the establishment of the PDU session to obtain the data structure with the importance value or range includes causation of a Policy Control Function (PCF) to evaluate at least the data relating to the request for establishment of the PDU session to generate PCC rules data with a PDU Set Importance value or range.

In another implementation, the determining of the one or more rules relating to the one or more functionalities of the at least one of (i) a UPF, or (ii) a computerized client device includes determining N4 rules data; and the at least one computer program is further configured to, when executed on the digital processing apparatus, cause the computerized network apparatus to: transmit the N4 rules data to the UPF for controlling traffic steering, switching and splitting in an downlink direction.

In yet another implementation, the determining of the one or more rules relating to the one or more functionalities of the at least one of (i) a UPF, or (ii) a computerized client device includes determining ATSSS rules data; and the at least one computer program is further configured to, when executed on the digital processing apparatus, cause the computerized network apparatus to: transmit the ATSSS rules data to the computerized client device for controlling traffic steering, switching and splitting in an uplink direction.

In another aspect of the disclosure, a computerized wireless user apparatus for use within a wireless network is disclosed. In one embodiment, the computerized wireless user apparatus includes: digital processing apparatus; at least one wireless network interface in data communication with the digital processing apparatus; and a storage device in data communication with the digital processing apparatus, the storage device having a storage medium with at least one computer program stored thereon.

In one variant, the at least one computer program is implemented to, when executed on the digital processing apparatus, cause the computerized wireless user apparatus to: transmit, to a computerized network device, first data relating to a request for establishment of a packet data unit (PDU) session; receive, from the computerized network device, second data including one or more rules and a parameter; evaluate one or more rules from the second data based on the parameter; and steer traffic to the computerized network device based on the one or more rules in accordance with the parameter.

In one implementation, the parameter includes a parameter relating to an importance of a PDU set.

In another implementation, the at least one computer program is further implemented to, when executed on the digital processing apparatus, cause the computerized wireless user apparatus to: determine whether the one or more rules are applicable to the PDU session based on wireless network configuration.

In yet another implementation, the at least one computer program is further implemented to, when executed on the digital processing apparatus, cause the computerized wireless user apparatus to: indicate, in the first data relating to the request for the establishment of the packet data unit (PDU) session, support for utilization of the one or more rules with the parameter.

In yet another implementation, the one or more rules include 3GPP ATSSS rules for the PDU session enhanced with a PDU Set Importance parameter.

In another aspect of the disclosure, a computer readable apparatus is disclosed. In one embodiment, the computer readable apparatus includes a non-transitory storage medium having at least one computer program stored thereon.

In one variant, the at least one computer program has a plurality of instructions, which are implemented to, when executed on a processing apparatus, cause a computerized network apparatus to: receive data representative of PCC rules having data indicating a PDU Set Importance parameter as part of one or more traffic descriptors; based on the data representative of PCC rules, generate an enhanced ATSSS rules data structure and an enhanced N4 rules data structure, each having data relating to the PDU Set Importance parameter; transmit the enhanced ATSSS rules data structure to a user device for controlling, in accordance with the PDU Set Importance parameter, traffic steering, switching and splitting in an uplink direction; and transmit the enhanced N4 rules data structure to a User Plane Function (UPF) for controlling, in accordance with the PDU Set Importance parameter, traffic steering, switching and splitting in a downlink direction.

In one implementation, the computerized network apparatus includes a session management function (SMF).

In another implementation, the plurality of instructions are further implemented to, when executed on the processing apparatus, cause the computerized network apparatus to: receive, from the user device, data representative of support for the enhanced ATSSS rules data structure; and receive, from the UPF, data representative of support for the enhanced N4 rules data structure.

In another variant, the at least one computer program has a plurality of instructions, which are implemented to, when executed on a processing apparatus, cause a User Plane Function (UPF) apparatus to: receive enhanced N4 rules with the PDU Set Importance from a session management function (SMF), the enhanced N4 rules with the PDU Set Importance generated by the SMF based on enhanced Policy and Charging Control (PCC) rules with the PDU Set Importance received by the SMF from a Policy Control Function (PCF); and based on the enhanced N4 rules with the PDU Set Importance, control traffic steering, switching and splitting in a downlink direction.

In one implementation, the plurality of instructions are further implemented to, when executed on the processing apparatus, cause the UPF apparatus to: transmit, to the SMF and within at least one of (i) N4/PFCP Association Setup signaling or (ii) N4/PFCP Association Update signaling, data representative of support for the enhanced N4 rules with the PDU Set Importance; and the receipt of the enhanced N4 rules with the PDU Set Importance is based on support for the enhanced N4 rules with the PDU Set Importance.

In another implementation, the receipt of the enhanced N4 rules with the PDU Set Importance includes receipt of multi-access rules (MAR) with the PDU Set Importance.

In another aspect of disclosure, computer readable apparatus is described. In one embodiment, the apparatus includes a storage medium configured to store one or more computer program. In embodiment, the apparatus includes a program memory or HDD or SSD on a computerized network controller device, such as MSO controller. In another embodiment, the apparatus includes a program memory, HDD or SSD on a computerized wireless network or device (e.g., PCF, SMF, UPF, user device (e.g., 5G-RG or UE)).

These and other aspects shall become apparent when considered in light of the disclosure provided herein.

### BRIEF DESCRIPTION OF THE DRAWINGS

FIG. 1 is a functional block diagram of a prior art 5G architecture and the various components thereof.

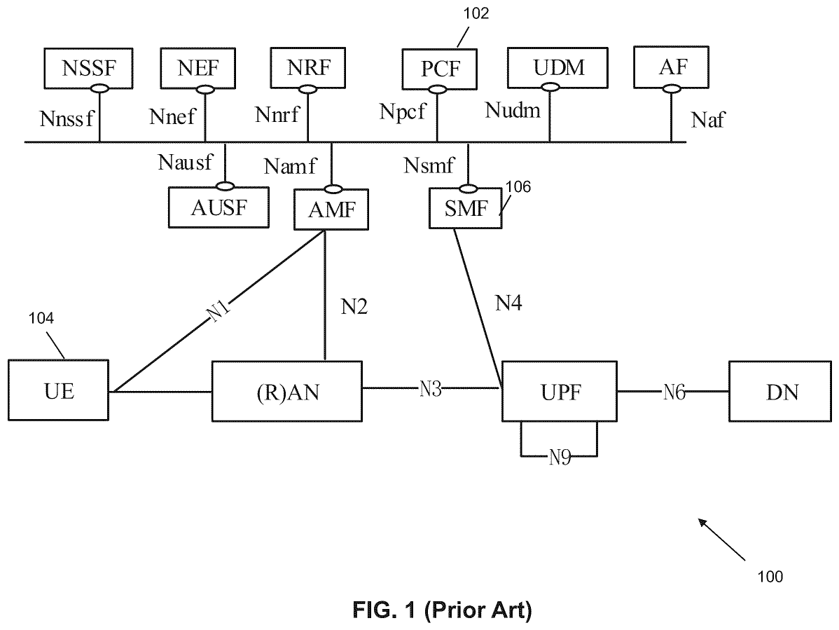

FIG. 2 is a tabular representation of a prior art 3GPP ATSSS rule framework.

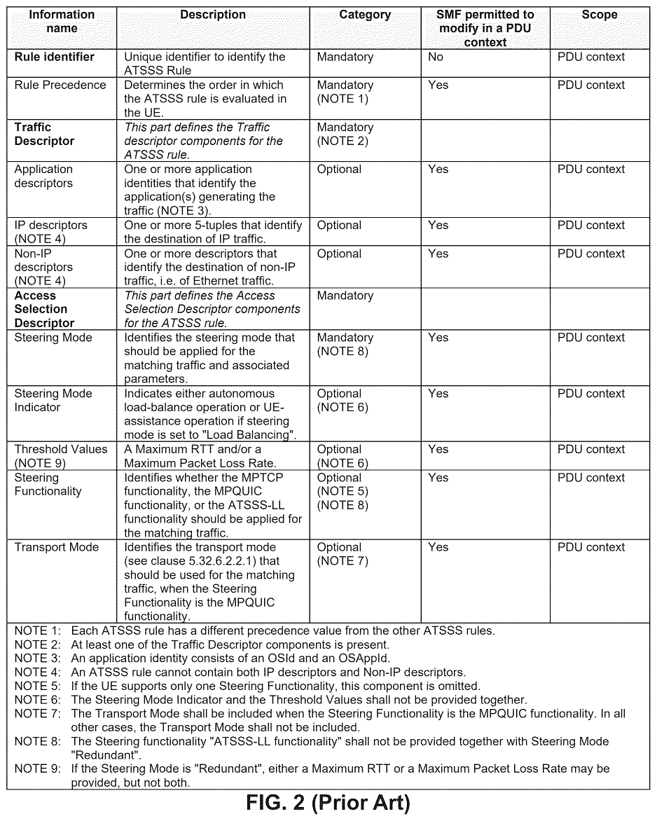

FIG. 2A is a functional block diagram of a prior art 3GPP architecture for ATSSS support.

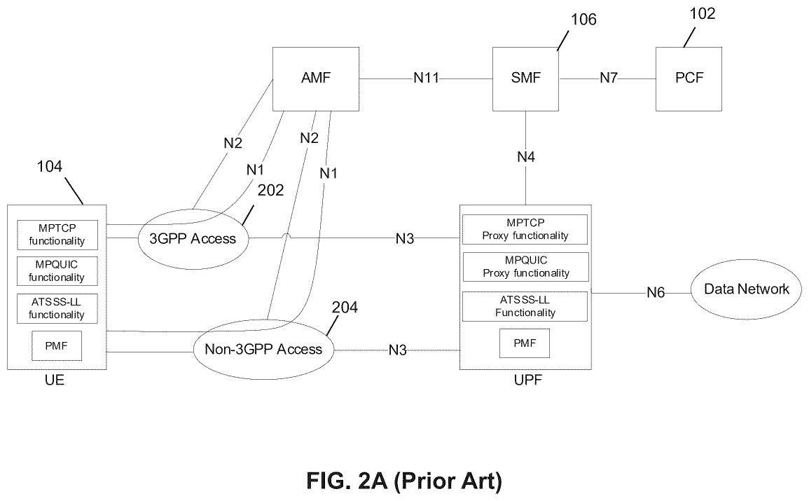

FIG. 3 is respective RTP Header Extensions for one-byte and two-byte for PDU set marking.

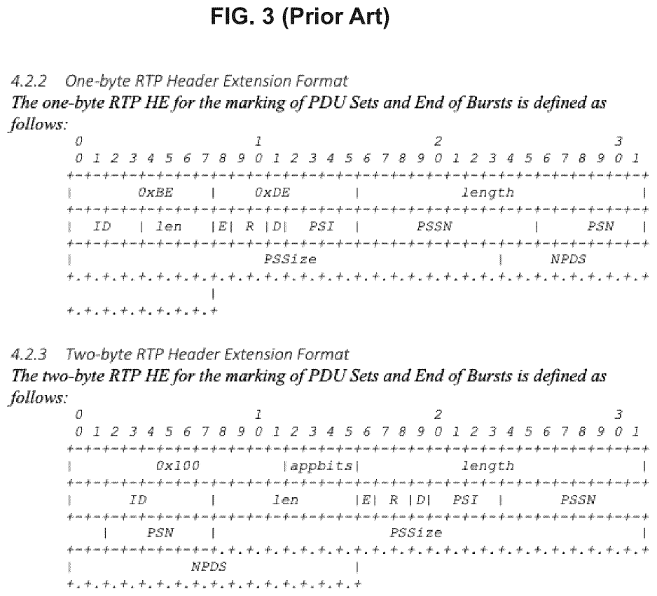

FIG. 4 is a functional block diagram illustrating a first exemplary embodiment of a roaming and non-roaming 3GPP 5GS architecture for enhanced traffic steering support with PDU Set Importance according to the present disclosure.

FIG. 5 is a functional block diagram illustrating a second exemplary embodiment of a roaming with home-routed 3GPP 5GS architecture for enhanced traffic steering support with PDU Set Importance according to the present disclosure.

FIG. 6 is a functional block diagram illustrating a third exemplary embodiment of a roaming with home-routed 3GPP 5GS enhanced traffic steering support with PDU Set Importance according to the present disclosure.

FIG. 7 is a ladder diagram illustrating an exemplary embodiment of communication flow between various network components (including UEe, UPFe, SMFe, and PCFe) according the present disclosure.

FIG. 8 is logical flow diagram illustrating one embodiment of a generalized method of utilizing PDU Set Importance data to enhance rules data according the present disclosure.

FIG. 8A is a logical flow diagram illustrating one exemplary implementation of the method of FIG. 8, wherein support for enhanced rule framework is indicated according to the present disclosure.

FIG. 8B is a logical flow diagram illustrating one exemplary implementation of the method of FIG. 8, wherein an enhanced 3GPP ATSSS and N4 framework is used as the basis of the traffic steering according to the present disclosure.

FIG. 9 is a tabular representation of an embodiment for an enhanced 3GPP ATSSSe data structure according to the present disclosure.

FIG. 10 is a logical flow diagram illustrating one embodiment of a generalized method for a user device (e.g., UEe or 5G-RG) performing enhanced traffic steering according to the present disclosure.

FIG. 10A is a logical flow diagram illustrating one implementation of the generalized method of FIG. 10, wherein a 3GPP UEe implements enhanced ATSSS steering functionality and PDU Set Importance is used as a basis therefor.

FIG. 10B is a logical flow diagram illustrating one implementation of the generalized method of FIG. 10, wherein support for enhanced rule framework is indicated according to the present disclosure.

FIG. 11 is a logical flow diagram illustrating one embodiment of a generalized method for an enhanced user plane function (UPFe) performing enhanced traffic steering, wherein support for enhanced rule framework is indicated according to the present disclosure.

FIG. 12 is a functional block diagram illustrating an exemplary embodiment of an enhanced 3GPP SMF (SMFe) apparatus useful with various embodiments of the present disclosure.

FIG. 13 is a functional block diagram illustrating an exemplary embodiment of an enhanced 3GPP PCF (PCFe) apparatus useful with various embodiments of the present disclosure.

FIG. 14 is a functional block diagram illustrating an exemplary embodiment of an enhanced 3GPP UE (UEe) apparatus useful with various embodiments of the present disclosure.

FIG. 15 is a functional block diagram illustrating an exemplary embodiment of an enhanced user plane function (UPFe) apparatus useful with various embodiments of the present disclosure.

### DETAILED DESCRIPTION

Reference is now made to the drawings wherein like numerals refer to like parts throughout.

As used herein, the term “access node” refers generally and without limitation to a network node which enables communication between a user or client device and another entity within a network, such as for example a 3GPP access (e.g., NG-RAN which includes a CBRS node) and non-3GPP access (e.g., trusted, untrusted, and wireline). Trusted/untrusted may include a Wi-Fi, and wireline may include a Cable Modem (CM).

As used herein, the term “application” (or “app”) refers generally and without limitation to a unit of executable software that implements a certain functionality or theme. The themes of applications vary broadly across any number of disciplines and functions (such as on-demand content management, e-commerce transactions, brokerage transactions, home entertainment, calculator etc.), and one application may have more than one theme. The unit of executable software generally runs in a predetermined environment;

for example, the unit could include a downloadable Java Xlet™ that runs within the JavaTV™ environment.

As used herein, the terms “client device” or “user device” or “UE” include, but are not limited to, Fifth Generation Residential Gateway (5G-RG), set-top boxes (e.g., DSTBs), gateways, modems, personal computers (PCs), and minicomputers, whether desktop, laptop, or otherwise, and mobile devices such as handheld computers, PDAs, personal media devices (PMDs), tablets, “phablets”, smartphones, and vehicle infotainment systems or portions thereof.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.) and the like.

As used herein, the term “headend” or “backend” refers generally to a networked system controlled by an operator (e.g., an MSO) that distributes programming to MSO clientele using client devices. Such programming may include literally any information source/receiver including, inter alia, free-to-air TV channels, pay TV channels, interactive TV, over-the-top services, streaming services, and the Internet.

As used herein, the terms “Internet” and “internet” are used interchangeably to refer to inter-networks including, without limitation, the Internet. Other common examples include but are not limited to: a network of external servers, “cloud” entities (such as memory or storage not local to a device, storage generally accessible at any time via a network connection, and the like), service nodes, access points, controller devices, client devices, etc.

As used herein, the term “LTE” refers to, without limitation and as applicable, any of the variants or Releases of the Long-Term Evolution wireless communication standard, including LTE-U (Long Term Evolution in unlicensed spectrum), LTE-LAA (Long Term Evolution, Licensed Assisted Access), LTE-A (LTE Advanced), and 4G/4.5G LTE.

As used herein, the term “memory” includes any type of integrated circuit or other storage device adapted for storing digital data including, without limitation, ROM, PROM, EEPROM, DRAM, SDRAM, DDR/2 SDRAM, EDO/FPMS, RLDRAM, SRAM, “flash” memory (e.g., NAND/NOR), 3D memory, and PSRAM.

As used herein, the terms “microprocessor” and “processor” or “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable computer fabrics (RCFs), array processors, secure microprocessors, and application-specific integrated circuits (ASICs). Such digital processors may be contained on a single unitary IC die, or distributed across multiple components.

As used herein, the terms “MSO” or “multiple systems operator” refer to a cable, satellite, or terrestrial network provider having infrastructure required to deliver services including programming and data over those mediums.

As used herein, the terms “MNO” or “mobile network operator” refer to a cellular, satellite phone, WMAN (e.g., 802.16), or other network service provider having infrastructure required to deliver services including without limitation voice and data over those mediums.

As used herein, the terms “network” and “bearer network” refer generally to any type of telecommunications or data network including, without limitation, hybrid fiber coax (HFC) networks, satellite networks, telco networks, and data networks (including MANs, WANs, LANs, WLANs, internets, and intranets). Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, LTE/LTE-A/LTE-U/LTE-LAA, 5G NR, WAP, SIP, UDP, FTP, RTP/RTCP, H.323, etc.).

As used herein, the term “network interface” refers to any signal or data interface with a component or network including, without limitation, those of the FireWire (e.g., FW400, FW800, etc.), USB (e.g., USB 2.0, 3.0. OTG), Ethernet (e.g., 10/100, 10/100/1000 (Gigabit Ethernet), 10-Gig-E, etc.), MoCA, Coaxsys (e.g., TVnet™), radio frequency tuner (e.g., in-band or OOB, cable modem, etc.), LTE/LTE-A/LTE-U/LTE-LAA, Wi-Fi (802.11), WiMAX (802.16), Z-wave, PAN (e.g., 802.15), or power line carrier (PLC) families.

As used herein the terms “5G” and “New Radio (NR)” refer without limitation to apparatus, methods or systems compliant with 3GPP Release 15, and any modifications, subsequent Releases, or amendments or supplements thereto which are directed to New Radio technology, whether licensed or unlicensed.

As used herein, the term “server” refers to any computerized component, system or entity regardless of form which is adapted to provide data, files, applications, content, or other services to one or more other devices or entities on a computer network.

As used herein, the term “storage” refers to without limitation computer hard drives, DVR device, memory, RAID devices or arrays, optical media (e.g., CD-ROMs, Laserdiscs, Blu-Ray, etc.), or any other devices or media capable of storing content or other information.

As used herein, the term “users” may include without limitation end users (e.g., individuals, whether subscribers of the MSO network, the MNO network, or other), the receiving and distribution equipment or infrastructure such as a CPE/FWA or CBSD, venue operators, third party service providers, or even entities within the MSO itself (e.g., a particular department, system or processing entity).

### Overview

In one exemplary aspect, the present disclosure provides improved methods and apparatus for providing wireless services which, inter alia, provide enhancements over extant functionality regarding steering traffic of a MA PDU Session for Multi Access (MA) Packet Data Unit (PDU) Session Establishment signaling flow.

Specifically, XRM data consists of PDU Sets that each PDU Set can have different level of relative importance. Accordingly, in one embodiment, the disclosed method and apparatus enhance a 3GPP ATSSS feature such that the PDU Set Importance of a PDU Set can be used as a criteria to select the appropriate ATSSS steering function and/or ATSSS steering mode to transfer the PDU Set over the 3GPP and/or non-3GPP access legs of a MA (Multi Access) PDU Session.

In one implementation of the disclosed method and apparatus, PCC rules (sent from PCF to SMF), N4 rules (sent from SMF to UPF) and ATSSS rules (sent from SMF to UE/5G-RG) are enhanced such that PDU Set Importance information of uplink and/or downlink XRM related user data traffic can be taken into consideration by the UE/5G-RG and/or by the UPF when selecting the appropriate ATSSS steering function and steering mode.

Utilization of these enhanced rule frameworks to provide integration of ATSSS (Access Traffic Steering, Switching, and Splitting) features with XRM by enabling the utilization of PDU Set Importance to prioritize the relative importance of PDU Sets within a QoS Flow.

Extending ATSSS feature to consider PDU Set Importance for traffic associated with XRM service, for example, allows mapping of PDU Sets of high importance to a specific ATSSS steering functionality (e.g., ATSSS-LL, MPTCP, or MPQUIC) and steering mode (e.g., Priority-based, Smallest Delay, or Redundant).

Additionally, in one embodiment, the PDU Session Establishment Request (defined TS 23.502, clause 4.3.2.2.1) is enhanced with information relating to whether the UEe (or enhanced 5G-RG) supports ATSSS rules enhancement with PDU Set Importance. The UEe (or enhanced 5G-RG) can inform 5GC (e.g., SMF) in the enhanced PDU Session Establishment Request or Modification signaling whether it supports ATSSS rules enhancement with PDU Set Importance. In one variant, based on this information, the SMFe can only provide this enhanced ATSSS rule to the UEe or 5G-RGe that supports this feature.

In yet another embodiment, N4/PFCP Association Setup or N4/PFCP Association Update signaling (defined in TS 29.244, clause 6.2.6 or 6.2.7, respectively) can be enhanced to indicate support for enhanced N4 rules with PDU Set Importance. The UPFe informs the SMFe in the enhanced N4/PFCP Association Setup or N4/PFCP Association Update signaling indicating support for enhanced N4 rules with PDU Set Importance. In one variant, based on this information, the SMF can only provide this enhanced N4 rules to the UPF that supports this feature.

In another embodiment, one or more of the enhanced data structures (e.g., PCCe, ATSSSe, and/or N4 rules) can be dynamically updated, such as based on at least one of (i) a change in the PDU Set Importance data, or (ii) one or more operator policies or parameters.

Notably, the foregoing methods and apparatus may be integrated into various types of wireless network architectures, such as e.g., (i) Mobile Network Operator (MNO) networks utilizing 3GPP protocols and licensed spectrum; (ii) Multiple Systems Operator (MSO) networks utilizing 3GPP protocols and non-3GPP protocols; and/or (iii) various combinations or hybrids of the foregoing, including those where an MNO and MSO cooperate to share infrastructure.

Moreover, network operators (regardless of type) are enabled by the methods and apparatus disclosed herein to utilize scarce (and sometimes costly) frequency spectrum resources, whether 3GPP or non-3GPP, so as to align better with their operational and business case needs through use of enhanced traffic steering policies on a PDU Set Importance basis.

In sum, as a result of 3GPP R19 specifying non-3GPP access support for XRM services, a framework for how XRM services can leverage ATSSS features is needed and disclosed herein. R19 ATSSS features do not leverage PDU Set Information, such as PDU Set Importance which identifies the relative importance of a PDU Set compared to other PDU Sets within a QoS Flow. This can result in inefficiencies (e.g., missing frames, jitter, increased latency), since all PDU sets are treated the same. By leveraging PDU Set Information to control steering features of multiple accesses, PDU sets can be prioritized over other PDU sets, leading to better QoE for users, in particular with respect to XRM services.

### DETAILED DESCRIPTION OF EXEMPLARY EMBODIMENTS

Exemplary embodiments of the apparatus and methods of the present disclosure are now described in detail. While these exemplary embodiments are described in the context of the previously mentioned wireless access nodes (e.g., gNBs) associated with or supported at least in part by a managed network of a service provider (e.g., MSO and/or MNO networks), other types of radio access technologies (“RATs”), other types of networks and architectures that are configured to deliver digital data (e.g., text, images, games, software applications, video and/or audio) may be used consistent with the present disclosure. Such other networks or architectures may be broadband, narrowband, or otherwise, the following therefore being merely exemplary in nature.

It will also be appreciated that while described generally in the context of a network providing service to a customer or consumer or end user or subscriber (i.e., within a prescribed service area, venue, or other type of premises), the present disclosure may be readily adapted to other types of environments including, e.g., outdoors, commercial/retail, or enterprise domain (e.g., businesses), or even governmental uses. Yet other applications are possible.

Also, while certain aspects such as certain types of PDU sessions are described primarily in the context of the well-known Internet Protocol (described in, inter alia, Internet Protocol DARPA Internet Program Protocol Specification, IETF RCF 791 (September 1981) and Deering et al., Internet Protocol, Version 6 (IPv6) Specification, IETF RFC 2460 (December 1998), each of which is incorporated herein by reference in its entirety), it will be appreciated that the present disclosure may utilize other types of protocols (and in fact bearer networks to include other internets and intranets) to implement the described functionality.

Further, while some aspects of the present disclosure are described in detail with respect to so-called 5G “New Radio” (3GPP Release 19 and TS 38.XXX Series Standards and beyond), such aspects are in some cases access technology “agnostic” and hence may be used across different access technologies, and can be applied to, inter alia, any type of P2MP (point-to-multipoint) or MP2P (multipoint-to-point) technology, including e.g., Qualcomm Multefire.

Other features and advantages of the present disclosure will immediately be recognized by persons of ordinary skill in the art with reference to the attached drawings and detailed description of exemplary embodiments as given below.

### Network Architecture—

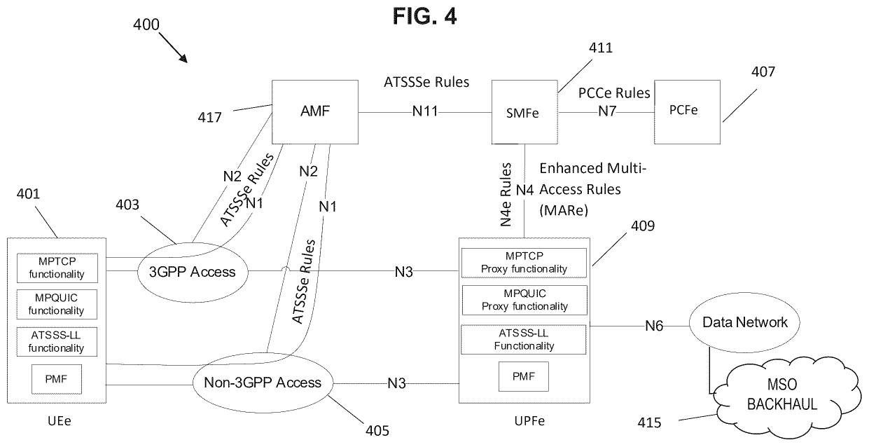

FIG. 4 is a functional block diagram illustrating a first exemplary embodiment of a roaming and non-roaming 3GPP 5GS architecture for enhanced ATSSS (ATSSSe) support utilizing PDU Set Importance data, according to the present disclosure. In the illustrated embodiment, the enhanced user equipment (UEe) 401 can obtain access over the user-plane (UP) of the 3GPP access 403 and/or the user-plane of the non-3GPP access 405, such access which can be steered or otherwise controlled by the various rules described herein. Specifically, as shown in FIG. 4, the architecture includes additional functionalities in the enhanced Policy Control Function (PCFe) 407, UEe 401, and enhanced User Plane Function (UPFe) 409 to process, store, and/or send PDU Set Importance data, as well as other parameters such as band usage, according to the present disclosure.

3GPP TS 26.522 clause 4.2 defines the RTP header extension (HE) for PDU Set marking. PDU Set marking can be performed by an RTP sender, such as an Application Server (e.g., MRF), a sender UE that sends media to an RTP receiver, such as a UE, or other 5G network components. PDU Set marking includes the PDU Set Importance data. Accordingly, the PCFe 407 can obtain from a sender, such as UEe 401 and/or application server (e.g., MRF).

In some embodiments, an operator of the PCFe 407 configures the enhanced Policy and Charging Control (PCCe) data structure(s) with the PDU Set Importance data. The PCFe 407 may in certain embodiments also include an enhanced PCF (PCFe) module, which processes data in support of PCFe rule generation/update functionality (e.g., PCCe rules having PDU Set Importance data included therewith). It is noted that the PCFe is a network function/module that generates the PCCe rules/data.

The illustrated enhanced session management function (SMFe) 411 may in certain embodiments also include an enhanced rules module, which processes the PCCe data received from the PCFe 407 in support of enhanced ATSSS and/or N4 rule generation/update functionality.

Additionally, the SMFe 411 and/or PCFe 407 may also include logic whereby they may instruct the UEe 401 and/or UPFe 409 to change the Steering Mode, and/or the “aggressiveness” of steering behavior between 3GPP and non-3GPP accesses 403, 405. The ATSSSe steering function logic in the UEe 401 and/or UPFe 409 enables traffic steering, switching and splitting across the 3GPP access and non-3GPP access, in accordance with the enhanced ATSSSe/N4e rules provided by the SMFe 411 based on the PCCe rules received from the PCFe.

FIG. 4 also illustrates a typical service provider network configuration 415 useful with the features of the enhanced steering apparatus and methods described herein. This service provider network 415 is used in one embodiment of the disclosure to provide backbone and backhaul from the service provider's service nodes, such as backhauling UP data nodes such as gNBs via HFC cable or FTTC/FTTH drops to different premises or venues/residences. For example, one or more stand-alone or embedded DOCSIS cable modems (CMs; not shown) are in data communication with the various NR architecture components (e.g., gNB) so as to provide two-way data communication to the served components. This connectivity also allows for logical communication between the PCFe 407 and any MSO or MNO-based network controller functions, such as ones disposed at a headend or hub of the MSO.

In certain embodiments, the service provider network 415 also advantageously permits the aggregation and/or analysis of subscriber- or account-specific data (including inter alia, particular UEe devices associated with such subscriber or accounts) as part of the provision of services to users under the exemplary delivery models described herein. As one example, device-specific IDs (e.g., IMSI, IMEI, MAC address or the like) can be cross-correlated to MSO subscriber data maintained at e.g., the “home” network head end(s) so as to permit or at least facilitate, among other things, (i) user/device authentication to the MSO network; (ii) correlation of aspects of the area, premises or venue where service is provided to particular subscriber capabilities (including band mapping for MSO-operated nodes), demographics, or equipment locations, such as for delivery of location-specific or targeted content or advertising; and (iii) determination of subscription level, and hence subscriber privileges and access to certain services or steering functionality as applicable. Moreover, device profiles for particular UEe devices can be maintained by the MSO, such that the MSO (or its automated proxy processes) can model the device for wireless or other capabilities.

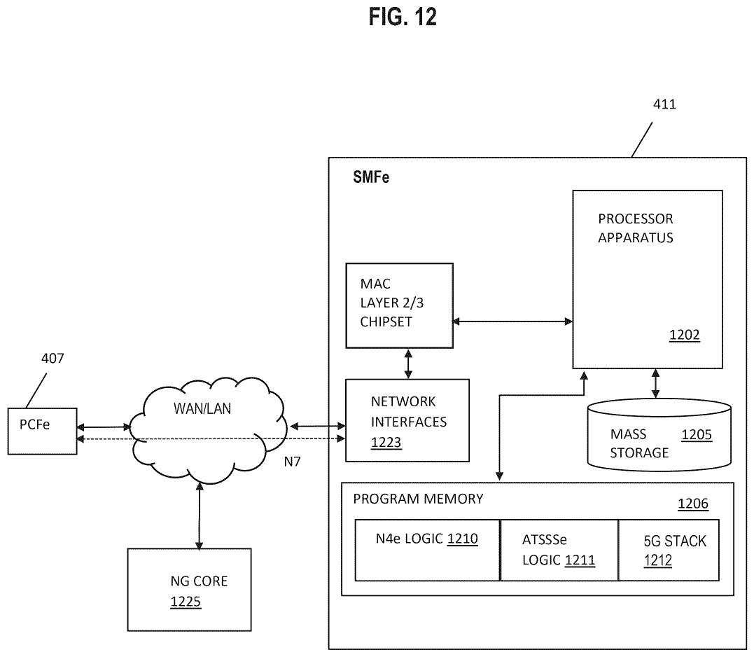

Details on the construction of exemplary embodiments of the SMFe 411, PCFe 407, UEe/5G-RGe 401 and UPFe 409 are described subsequently herein with respect to FIGS. 12-15, respectively.

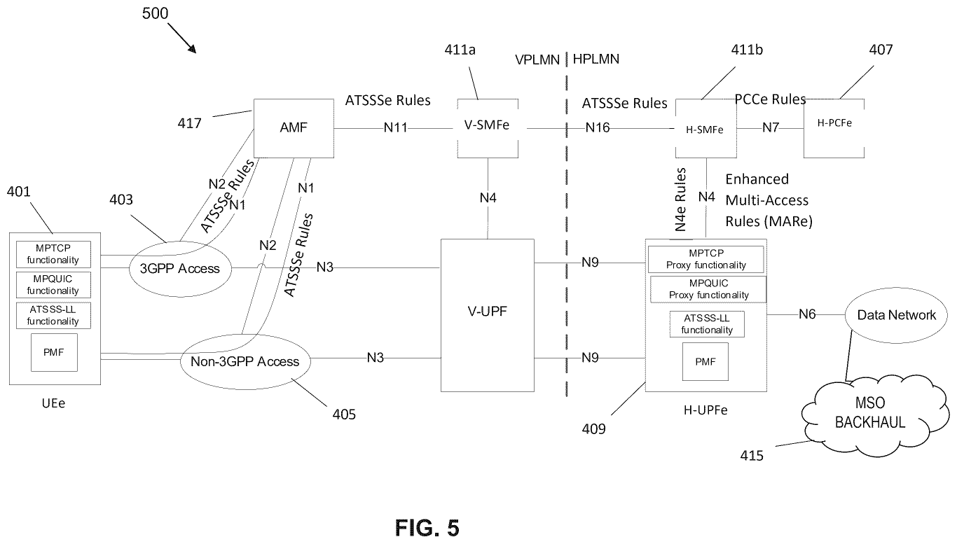

FIG. 5 is a functional block diagram illustrating a second exemplary embodiment of a roaming with home-routed 3GPP 5GS architecture for ATSSSe support according to the present disclosure.

The illustrated embodiment supports a roaming case with home-routed traffic when the UEe is registered to the same VPLMN over a 3GPP access 403 and non-3GPP access 405.

In this architecture, the MPTCP Proxy functionality and the MPF are located in the Home UPF (H-UPF). The AMF 417 is located in VPLMN, and the PCFe functionality (H-PCFe 407) is located in the HPLMN, while the V-SMFe 411a is also located in the VPLMN. The enhanced modules PCFe 407, SMFe 411, and ATSSSe, N4e and MARe rules are described previously with reference to FIG. 4.

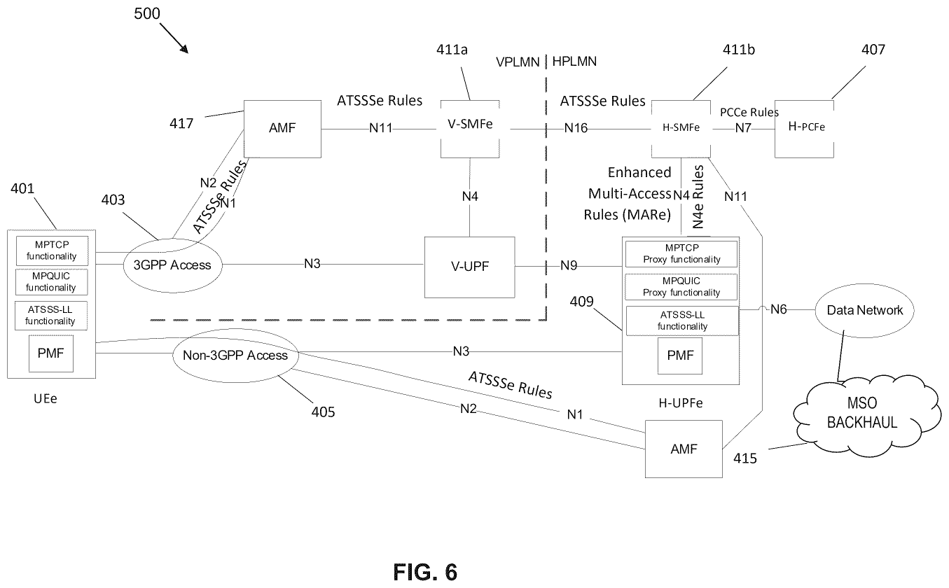

FIG. 6 is a functional block diagram illustrating a third exemplary embodiment of a roaming with home-routed 3GPP 5GS architecture for ATSSSe support according to the present disclosure.

The illustrated embodiment supports a roaming case with home-routed traffic when the UEe 401 is registered to VPLMN over the 3GPP access 403 and to Home Public Land Mobile Network (HPLMN) over the non-3GPP access 405 (i.e. the UEe 401 is registered to a different PLMN). Specifically, as shown in FIG. 6, the MPTCP Proxy functionality and the PMF are located in the Home UPF (H-UPF). The AMF 417 is located in VPLMN, and the H-PCFe 407 is located in the HPLMN. Advantageously, since standardized 5GS protocols and interfaces are utilized, communication between the various entities of each of FIGS. 4-6 is straightforward (i.e., as opposed to proprietary protocols utilized in each domain). The enhanced modules PCFe 407, SMFe 411, and ATSSSe, N4e and MARe rules are described previously with reference to FIG. 4.

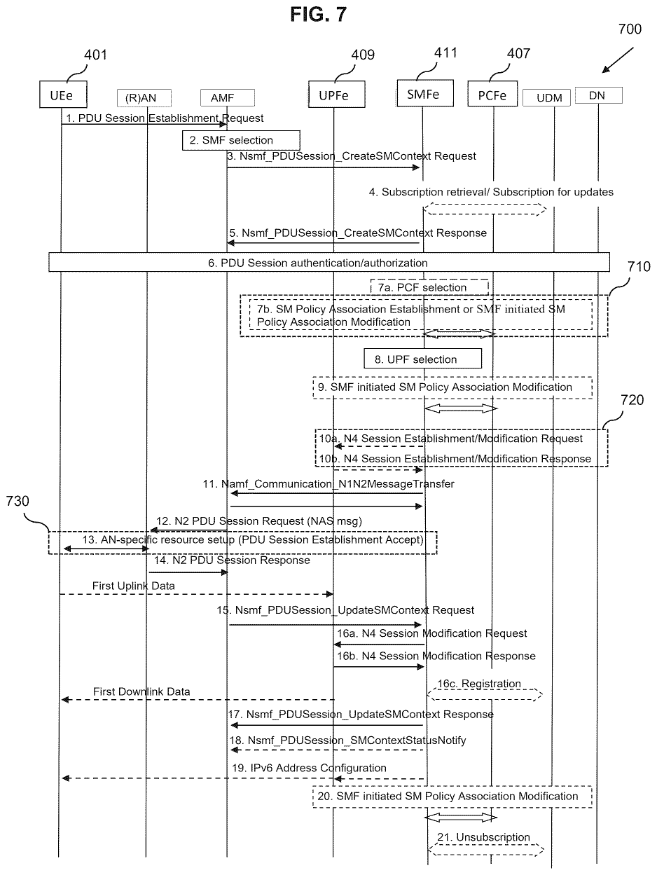

FIG. 7 is a ladder diagram illustrating an exemplary embodiment of communication flow between UEe 401, UPF (e) 409, SMF (e) 411, and PCFe 407 according the present disclosure.

As a preliminary matter, the communication flow of FIG. 7 in certain embodiments can be applied for a MA PDU Session establishment when the UE is not roaming, or when the UE is roaming and the PDU Session Anchor (PSA) is located in the VPLMN.

The PDU Session Establishment Request message may be sent over the 3GPP access or over the non-3GPP access.

Also, before the communication flow of FIG. 7 begins, in one variant of the present disclosure, the UPFe 409 can optionally inform SMFe 411 in N4/PFCP Association Setup or N4/PFCP Association Update signalling (defined in TS 29.244, clause 6.2.6 or 6.2.7, respectively) indicating support for enhanced N4 rules with PDU Set Importance. As explained infra with respect to at least FIG. 7, based on this information, the SMFe 411 can only provide the N4e rules data to the UPF that supports this feature. Likewise, in some variants, non-support for N4e rules with PDU Set Importance can be indicated by an absence of data indicating support for N4e rules with PDU Set Importance.

Now referring to step 1 of FIG. 7, the UE provides Request Type as “MA PDU Request” in UL NAS Transport message and its ATSSS Capabilities, as defined in clause 5.32.2 of TS 23.501 in PDU Session Establishment Request message. The PDU Session Establishment Request message may be sent over the 3GPP access or over the non-3GPP access.

In one variant of the present disclosure, the UE (or 5G-RG) 401 can optionally inform the 5GC (i.e., SMFe 411) in the PDU Session Establishment Request (TS 23.502, clause 4.3.2.2.1) signalling whether it supports ATSSS rules enhancement with PDU Set Importance. Based on this information, the SMF can only provide this enhanced ATSSS rule to the UE/5G-RG that supports this feature, as explained in more detail infra with respect to at least FIG. 7. Likewise, in some variants, non-support for enhanced ATSSS rules with PDU Set Importance can be indicated by an absence of data indicating support for enhanced ATSSS rules with PDU Set Importance.

The “MA PDU Request” Request Type in the UL NAS Transport message indicates to the network that this PDU Session Establishment Request is to establish a new MA PDU Session and to apply one or more steering functionalities (defined in TS 23.501, clause 5.32.6) for steering the traffic of this MA PDU session over multiple accesses.

If the UE requests an S-NSSAI and the UE is registered over both accesses, it requests an S-NSSAI that is allowed on both accesses.

The UE indicates to AMF whether it supports non-3GPP access path switching, i.e. whether the UE can transfer the non-3GPP access path of the MA PDU Session from a source non-3GPP access (N3IWF/TNGF) to a target non-3GPP access (a different N3IWF/TNGF).

In step 2, if the AMF supports MA PDU sessions, then the AMF selects an SMF (e.g., SMFe), which supports MA PDU sessions. If the AMF supports non-3GPP access path switching and the UE indicated in step 1 that the UE supports non-3GPP access path switching, the AMF selects an SMF (e.g., SMFe) that supports non-3GPP access path switching, if such an SMF is available.

In step 3, the AMF informs the SMFe that the request is for a MA PDU Session by including “MA PDU Request” indication and in addition, it indicates to SMF whether the UE is registered over both accesses. If the AMF determines that the UE is registered via both accesses, but the requested S-NSSAI is not allowed on both accesses, then the AMF rejects the MA PDU session establishment. If the AMF supports non-3GPP access path switching while maintaining two N2 connections for non-3GPP access, the selected SMFe supports non-3GPP path switching and UEe indicated in step 1 that the UEe supports non-3GPP access path switching, the AMF indicates whether the UEe supports non-3GPP path switching to the SMFe.

The AMF rejects the PDU Session Establishment request if the request is for a LADN.

In step 4, the SMF retrieves, via Session Management subscription data, the information whether the MA PDU session is allowed or not.

In step 5, if the SMF received Nsmf_PDUSession_CreateSMContext Request in step 3 and the SMFe is able to process the PDU Session establishment request, the SMFe creates an SM context and responds to the AMF by providing an SM Context ID.

In step 6, the SMF performs a secondary authentication if the request in step 3 indicates that the secondary authentication is required.

In step 7, if dynamic PCC is to be used for the MA PDU Session, the SMF sends an “MA PDU Request” indication to the PCFe in the SM Policy Control Create message and the ATSSS Capabilities of the MA PDU session. The SMFe provides the currently used Access Type(s) and RAT Type(s) to the PCFe. The PCFe decides whether the MA PDU session is allowed or not based on operator policy and subscription data.

However, one salient difference between the signalling flow of extant signalling flow (i.e., that provided in TS 23.502 V19.1.0 clauses 4.22.2.1) and FIG. 7 of the present disclosure is that-instead of the PCF merely providing PCC rules that include MA PDU session control information (as specified in TS 23.503)—the PCFe 407, per step 710 of FIG. 7, sends enhanced PCC (PCCe) rules which include PDU Set Importance data. From the received PCCe rules, the SMFe 411 derives (a) enhanced ATSSS rules, which will be sent to UEe 401 for controlling the traffic steering, switching and splitting in the uplink direction and (b) N4e rules, which will be sent to UPFe 409 for controlling the traffic steering, switching and splitting in the downlink direction.

If the UEe 401 indicates the support of “ATSSS-LL Capability,” the SMFe 411 may derive the Measurement Assistance Information.

If the SMF receives a UP Security Policy for the PDU Session with Integrity Protection set to “Required” and the MA PDU session is being established over non-3GPP access, the SMF does not verify whether the access can satisfy the UP Security Policy.

The remaining steps of FIG. 7 relate to, inter alia, the SMFe 411 establishing the user-plane resources over the 3GPP access, i.e. over the access where the PDU Session Establishment Request was sent.

In step 8, the SMFe selects one or more UPFs (e.g., UPFe) as needed as described in 3GPP document TS 23.501. In the case of PDU Session Type IPv4 or IPv6 or IPv4v6, the SMFe allocates an IP address/prefix for the PDU Session (unless configured otherwise) as described in TS 23.501 clause 5.8.2. In the case of PDU Session Type IPv6 or IPv4v6, the SMFe also allocates an interface identifier to the UEe for the UEe to build its link-local address. For Unstructured PDU Session Type the SMFe may allocate an IPv6 prefix for the PDU Session and N6 point-to-point tunnelling (based on UDP/IPv6) as described in TS 23.501 clause 5.6.10.3. For Ethernet PDU Session Type, neither a MAC nor an IP address is allocated by the SMFe to the UE for this PDU Session.

In step 9, the SMFe may initiate an SM policy Association Modification (AM) procedure as defined in clause 3GPP document TS 23.502 to provide information on the Policy Control Request Trigger (PCRT) condition(s) that have been met. If Request Type is “initial request” and dynamic PCC is deployed and PDU Session Type is IPv4 or IPv6 or IPv4v6, SMFe notifies the PCFe (if the Policy Control Request Trigger condition is met) with the allocated UE IP address/prefix(es).

In step 720 of FIG. 7, the enhanced N4 rules derived by SMFe 411 for the MA PDU session are sent to UPFe 409 and two N3 UL CN tunnels info are allocated by the UPFe 409. If the ATSSS LL functionality is supported for MA PDU Session, the SMFe 411 may instruct the UPFe 409 to initiate performance measurement for this MA PDU Session. If the MPTCP functionality and/or the MPQUIC functionality is supported for the MA PDU Session, the SMFe 411 may instruct the UPFe 409 to activate the MPTCP functionality and/or the MPQUIC functionality for this MA PDU Session.

In step 10a, the UPFe 409 allocates addressing information for the Performance Measurement Function (PMF) in the UPFe 409. If the UPF receives from the SMFe 605 a list of QoS flows over which access performance measurements may be performed, the UPF allocates different UDP ports or different MAC addresses per QoS flow per access. In step 10b, the UPFe sends the addressing information for the PMF in the UPFe to the SMFe 605. If UDP ports or MAC addresses are allocated per QoS flow and per access, the UPFe sends the PMF IP address information and UDP ports with the related QFI to the SMFe in the case of IP PDU sessions and sends the MAC addresses with the related QFI to the SMFe in the case of Ethernet PDU sessions.

Additionally, in step 10a, if the message from the SMFe instructs the UPFe to activate MPTCP functionality, the UPFe allocates the UE “MPTCP link-specific multipath” addresses/prefixes. In step 10b, the UPFe sends the “MPTCP link-specific multipath” addresses/prefixes and MPTCP proxy information to the SMFe. If the message from the SMFe instructs the UPFe to activate MPQUIC functionality, the UPFe allocates the UE “MPQUIC link-specific multipath” addresses/prefixes. In step 10b, the UPF sends the “MPQUIC link-specific multipath” addresses/prefixes and MPQUIC proxy information to the SMF. The “MPTCP link-specific multipath” addresses/prefixes and the “MPQUIC link-specific multipath” addresses/prefixes may be the same.

In step 11, for the MA PDU session, the SMFe includes an “MA PDU session Accepted” indication in the Namf_Communication_N1N2Message Transfer message to the AMF and indicates to AMF that the N2 SM Information included in this message should be sent over 3GPP access. The AMF marks this PDU session as MA PDU session based on the received “MA PDU session Accepted” indication. If the AMF indicated in step 3 that non-3GPP path switching while maintaining two N2 connections for non-3GPP access is supported, the SMF indicates support of non-3GPP path switching in the PDU Session Establishment Accept message.

In step 12, the AMF may initiate an N2 PDU session request to RAN. If the N2 SM information is not included in the step 11, an N2 Downlink NAS Transport message is used instead. The AMF sends the NAS message containing PDU Session ID and PDU Session Establishment Accept targeted to the UE and the N2 SM information received from the SMF within the N2 PDU Session Request to the (R)AN. If the SMF derived CN assisted RAN parameters tuning are stored for the activated PDU Session(s), the AMF may derive updated CN assisted RAN parameters tuning and provide them the (R)AN.

In step 13, the UEe 401 receives a PDU Session Establishment Accept message, which indicates to UEe 401 that the requested MA PDU session was successfully established.

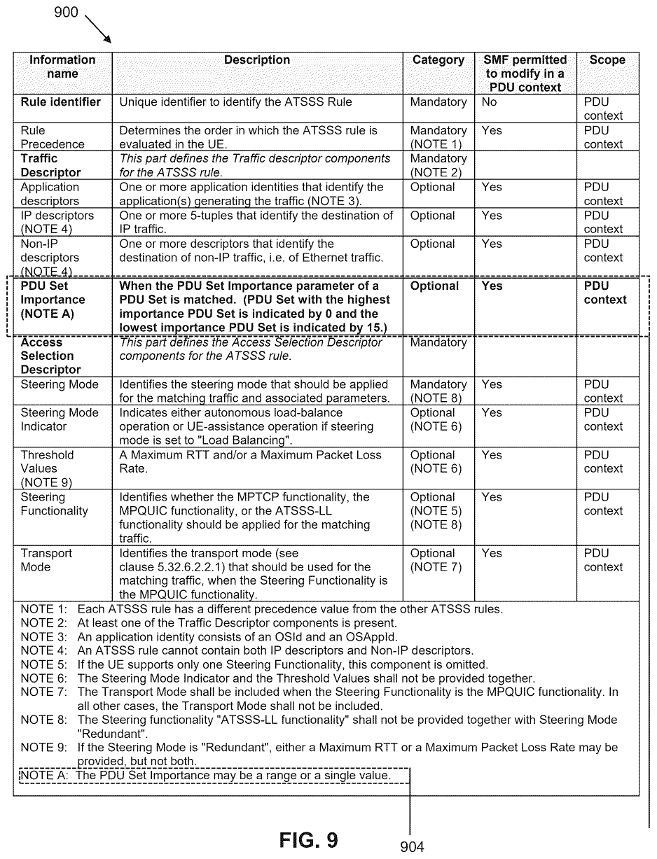

In step 730 of FIG. 7, this PDU Session Establishment Accept message includes the enhanced ATSSS rules (see the exemplary enhanced ATSSS rules data structure 900 of FIG. 9) for the MA PDU session, which were derived by SMFe 411.

If the ATSSS-LL functionality is supported for the PDU Session, the SMFe 411 may include the addressing information of PMF in the UPF into the Measurement Assistance Information. If the MPTCP functionality is supported for the MA PDU Session, the SMFe 411 includes the “MPTCP link-specific multipath” addresses/prefixes of the UEe 401 and the MPTCP proxy information. If the MPQUIC functionality is supported for the MA PDU Session, the SMFe 411 shall include the “MPQUIC link-specific multipath” addresses/prefixes of the UEe 401 the MPQUIC proxy information.

In step 14, RAN may initiate an N2 PDU Session Response (PDU Session ID, Cause, N2 SM information (PDU Session ID, AN Tunnel Info, List of accepted/rejected QFI(s), User Plane Enforcement Policy Notification)) to AMF. The AN Tunnel Info corresponds to the Access Network address of the N3 tunnel corresponding to the PDU Session. If the (R)AN rejects QFI(s) the SMF is responsible of updating the QoS rules and QoS Flow level QoS parameters if needed for the QoS Flow associated with the QoS rule(s) in the UE accordingly. The NG-RAN rejects the establishment of UP resources for the PDU Session when it cannot fulfil User Plane Security Enforcement information with a value of Required. The NG-RAN notifies the SMF when it cannot fulfil a User Plane Security Enforcement with a value of Preferred. If the NG-RAN cannot establish redundant user plane for the PDU Session as indicated by the RSN parameter, the NG-RAN takes the decision on whether to reject the establishment of RAN resources for the PDU Session based on local policies as described in TS 23.501.

In step 15, AMF may initiate Nsmf_PDUSession_UpdateSMContext Request to SMF The AMF forwards the N2 SM information received from (R)AN to the SMF. If the list of rejected QFI(s) is included in N2 SM information, the SMF shall release the rejected QFI(s) associated QoS profiles. If the N2 SM information indicates failure of user plane resource setup, the SMF shall reject the PDU session establishment by including a N1 SM container with a PDU Session Establishment Reject message (see clause 8.3.3 of TS 24.501) in the Nsmf_PDUSession_UpdateSMContext Response in step 17. Step 16 is skipped in this case and instead the SMF releases the N4 Session with UPF. If the User Plane Enforcement Policy Notification in the N2 SM information indicates that no user plane resources could be established, and the User Plane Enforcement Policy indicated “required” as described in clause 5.10.3 of TS 23.501, the SMF rejects the PDU session establishment by including a N1 SM container with a PDU Session Establishment Reject message (see clause 8.3.3 of TS 24.501) in the Nsmf_PDUSession_UpdateSMContext Response in step 17. Step 16 is skipped in this case.

In step 16a, the SMFe initiates an N4 Session Modification procedure with the UPFe. The SMF provides AN Tunnel Info to the UPF as well as the corresponding forwarding rules. If SMFe decides to perform redundant transmission for one or more QoS Flows of the PDU, the SMFe also indicates the UPF to perform packet duplication for the QoS Flow(s) in downlink direction by forwarding rules. In the case of redundant transmission with two I-UPFs for one or more QoS Flows of the PDU, the SMF provides AN Tunnel Info to two I-UPFs and also indicates the UPF (PSA) to perform packet duplication for the QoS Flow(s) in downlink direction by forwarding rules. The SMF also provides the UL Tunnel Info of the UPF (PSA) to the two I-UPFs and the DL Tunnel Info of the two I-UPFs to the UPF (PSA).

In step 16b, the UPFe provides an enhanced N4 Session Modification Response to the SMFe. If multiple UPFs are used in the PDU Session, the UPFe in step 16 refers to the UPF terminating N3. After this step, the UPFe delivers any down-link packets to the UEe that may have been buffered for this PDU Session.

In step 16c, if Request Type in step 3 indicates neither “Emergency Request” nor “Existing Emergency PDU Session” and, if the SMF has not yet registered for this PDU Session, then the SMF registers with the UDM using Nudm_UECM_Registration (SUPI, DNN, S-NSSAI, PDU Session ID, SMFe Identity, Serving PLMN ID, [NID]) for a given PDU Session. As a result, the UDM stores following information: SUPI, SMF identity and the associated DNN, S-NSSAI, PDU Session ID and Serving Network (PLMN ID, [NID], see clause 5.18 of TS 23.501). The UDM may further store this information in UDR by Nudr_DM_Update (SUPI, Subscription Data, UE context in SMF data).

In step 17, SMFe may initiate Nsmf_PDUSession_UpdateSMContext Response tp AMF. The SMF may subscribe to the UE mobility event notification from the AMF (e.g. location reporting, UE moving into or out of Area Of Interest), after this step by invoking Namf_EventExposure_Subscribe service operation as specified in clause 5.2.2.3.2. For LADN, the SMFe subscribes to the UEe moving into or out of LADN service area event notification by providing the LADN DNN as an indicator for the Area Of Interest (see clause 5.6.5 and 5.6.11 of TS 23.501.

In step 18, SMFe may initiate Nsmf_PDUSession_SMContextStatusNotif to AMF. If during the procedure, any time after step 5, the PDU Session establishment is not successful, the SMF informs the AMF by invoking Nsmf_PDUSession_SMContextStatusNotify (Release). The SMF also releases any N4 session(s) created, any PDU Session address if allocated (e.g. IP address) and releases the association with PCF, if any. In this case, step 19 is skipped.

After step 18, if the SMFe was informed in step 2 that the UEe is registered over both accesses, then the SMF initiates the establishment of user-plane resources over non-3GPP access too. The SMFe sends an Namf_Communication_N1N2MessageTransfer to the AMF including N2 SM Information and indicates to AMF that the N2 SM Information should be sent over non-3GPP access. Namf_Communication_N1N2MessageTransfer does not include an N1 SM Container for the UE because this was sent to UEe in step 13. After this step, the two N3 tunnels between the PSA and RAN/AN are established.

The last step above is not executed when the UE is registered over one access only, in which case the MA PDU Session is established with user-plane resources over one access only. How user-plane resources can be added over an access of the MA PDU Session is specified in clause 4.22.7.

In step 19, SMF may generates an IPv6 Router Advertisement and sends it to the UEe. If Control Plane CIoT 5GS Optimisation is enabled for this PDU Session the SMFe sends the IPv6 Router Advertisement via the AMF for transmission to the UEe using the Mobile Terminated Data Transport in Control Plane CIoT 5GS Optimisation procedures (see clause 4.24.2), otherwise the SMF sends the IPv6 Router Advertisement via N4 and the UPF.

In step 20, If the UEe has indicated support of transferring Port Management Information Containers, then SMF informs PCF that a 5GS Bridge information is available. SMF also includes the port number of the DS-TT Ethernet port, MAC address of the DS-TT Ethernet port, 5GS Bridge ID, Port Management Information Container and UE-DSTT Residence Time as provided by the UE. AF calculates the bridge delay for each port pair, i.e. composed of DS-TT Ethernet port and NW-TT Ethernet port, using the UE-DS-TT Residence Time for all NW-TT Ethernet port(s) serving the 5GS Bridge indicated by the 5GS Bridge ID. The SMF may inform PCFe that a manageable NW-TT Ethernet port has been detected. If SMF received a Port Management Information Container from the UPF, then SMFe provides the Port Management Information Container to the PCFe as described in clause 5.28.3.2 of TS 23.501.

### Methods—

### 1. Enhanced Traffic Steering Rules and Policies—

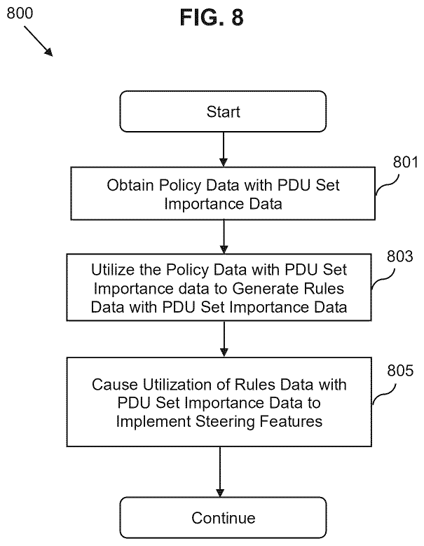

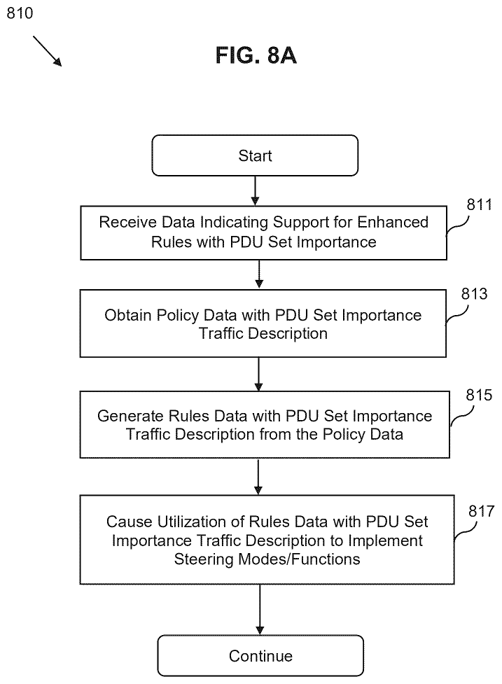

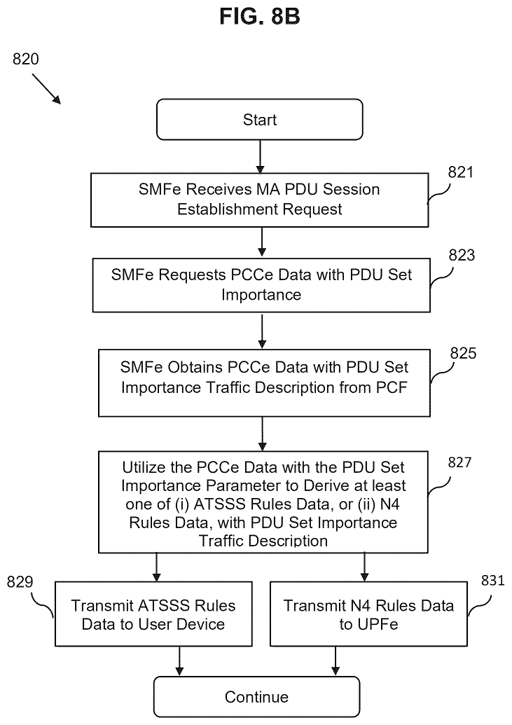

Referring now to FIG. 8, one embodiment of a generalized method of utilizing enhanced traffic routing or steering functionality (including e.g., 3GPP ATSSS functionality) according to the present disclosure is described in detail.

As shown, the method 800 includes first obtaining, at a network process or entity (e.g., an enhanced session management function (SMFe) 411), enhanced policy data including data representative of a PDU Set Importance parameter or value(s), per step 801. In one variant, the enhanced policy data is enhanced Policy and Charging Control (PCC) rules (or PCCe rules) data, including PDU Set Importance as a traffic descriptor, received from PCFe 407.

As explained in 3GPP TS 26.522 clause 4.2.1, PDU Set marking can be performed by an RTP sender, such as an Application Server (e.g., MRF), a sender UE that sends media to an RTP receiver, such as a UE, or other 5G network components. PDU Set marking includes the PDU Set Importance. Accordingly, in one variant, a network process or entity (e.g., an enhanced Policy Control Function (PCFe) 407) can obtain the PDU Set Importance via extraction from the PDU Set marking and configure the PCCe data therewith. Then the enhanced PCC data with the PDU Set Importance data is sent to an enhanced session management function (SMFe) 411. In one implementation, the PCFe 407 provides the PCCe rules that include MA PDU session control information.

Per step 803, the enhance policy data (PCCe data) with the PDU Set Importance data is utilized to enhance rules data (e.g., PCCe, ATSSS and/or N4 rules data) with data indicating the PDU Set Importance data. In one variant, the SMFe 411 derives the ATSSSe and/or N4e rules with the PDU Set Importance data from the PCCe data with the PDU Set Importance data, based on receipt of the PCCe data with the PDU Set Importance data from the PCFe 407.

In one variant, step 803 includes the PCFe 407 sending the PCCe rules to SMFe 411.

Lastly, per step 805, the enhanced rules data (e.g., PCCe, ATSSSe and/or N4e rules) with the with the PDU Set Importance data is utilized to implement one or more traffic steering features (i.e., modes and/or functions).

In one variant, step 805 includes the SMFe 411 sending the ATSSSe rules with the PDU Set Importance data to the UEe 401 for controlling the traffic steering, switching and splitting in the uplink direction. See step 829 of FIG. 8B. As shown in, e.g., FIG. 4, this ATSSSe data, in one implementation, is sent, via the AMF 417, over N11, N1, and N2 to the UEe. Additionally, see FIG. 9 for an exemplary ATSSSe data structure 900, which may be sent to the UEe 401 as part of step 805.

In another variant, step 805 includes the SMFe 411 sending the N4e rules with the PDU Set Importance data to the UPFe 409 for controlling the traffic steering, switching and splitting in the downlink direction. See step 831 of FIG. 8B.

FIGS. 8A and 8B are logical flow diagrams illustrating respective exemplary implementations 810 and 820 of the method of FIG. 8.

As shown in FIG. 8A, per step 811, data indicating support for enhanced rules data with PDU Set Importance is received by a network process or entity (e.g., SMFe 411).

In one variant, at least one of a UEe or 5G-RGe 401 informs 5GC (i.e., SMFe 411) in PDU Session Establishment Request signaling whether it supports ATSSS rules enhancement with PDU Set Importance. See step 821 of FIG. 8B for the step relating to receiving of the PDU Session Establishment Request. See also step 1 of FIG. 7. Based on this information, the SMFe 411 can only provide this enhanced ATSSS rule to the UE/5G-RG 401 that supports this feature.

Per step 813, the method retrieves policy data PCCe by an by analyzing the PDU set's characteristics and assigning PSI to different types of network traffic. In one implementation, when an incoming packet is identified to have an associated PDU PSI, a predefined steering mode is applied to direct the packet through the network accordingly. The steering mode is determined based on the PSI of the PDU set, ensuring optimized routing, resource allocation, and network efficiency.

Per step 815, the method generates enhanced rules based on PDU PSI from the obtained policy data of step 813 (e.g., PCCe, ATSSSe, N4e rules).

In one variant, step 813 includes the PCFe 407 sending the PCCe rules to SMFe 411.

In one variant, the SMFe 411 derives the ATSSSe and/or N4e rules with the PDU Set Importance data from the PCCe data with the PDU Set Importance data, based on receipt of the PCCe data with the PDU Set Importance data from the PCFe 407.

Lastly, per step 817, the enhanced rules data (e.g., PCCe, ATSSSe and/or N4e rules) with the PDU Set Importance data is utilized to implement one or more traffic steering features (i.e., modes and/or functions).

In one variant, step 817 includes the SMFe 411 sending the ATSSSe rules with the PDU Set Importance data to the UEe 401 for controlling the traffic steering, switching and splitting in the uplink direction.

In another variant, step 817 includes the SMFe 411 sending the N4e rules with the PDU Set Importance data to the UPFe 409 for controlling the traffic steering, switching and splitting in the downlink direction. See step 831 of FIG. 8B.

In another variant, a UPFe 409 informs the SMFe 411 in N4/PFCP Association Setup or N4/PFCP Association Update signaling indicating support for enhanced N4 rules with PDU Set Importance. Based on this information, the SMFe 411 can only provide this enhanced N4 rule to the UPFe 409 that supports this feature.

Now turning to method 820 of FIG. 8B, the SMFe 411 receives data representative of a PDU Session Establishment Request, per step 821. As explained supra with respect to FIG. 8A, in one variant, this data representative of the PDU Session Establishment Request can include data indicating whether the UEe 401 supports ATSSS rules enhancement with PDU Set Importance.

Per step 823, the SMFe 411 transmits data representative of a request for enhanced PCC (PCCe) data (PCCe rules) with a PDU Set Importance parameter or value(s) from the PCFe 407. In one variant, this data representative of the request for PCCe data is included within an indication of the MA PDU Session Establishment Request sent to the PCFe 407.

Per step 825, the SMFe 411 obtains the PCCe data (PCCe rules) with the PDU Set Importance parameter or value(s) from the PCFe 407.

Per step 827, the SMFe 411 utilizes the PCCe data (PCCe rules) with the PDU Set Importance parameter or value(s) to derive enhanced rules data (i.e., at least one of (i) ATSSSe, or (ii) N4e data).

In one variant, step 827 includes the SMFe 411 utilizing the PCCe data (PCCe rules) with the PDU Set Importance parameter or value(s) to derive enhanced ATSSS (ATSSSe) data having the with the PDU Set Importance parameter or value(s), which is then sent to the UEe 401 to control the traffic steering, switching and splitting in the uplink direction.

In another variant, step 827 includes the SMFe 411 utilizing the PCCe data (PCCe rules) with the PDU Set Importance parameter or value(s) to derive enhanced N4 (N4e) or enhanced multi-access rules (MARe) data having the with the PDU Set Importance parameter or value(s), which is then sent to the UPFe 409 to control the traffic steering, switching and splitting in the downlink direction.

FIG. 9 illustrates an exemplary enhanced 3GPP ATSSS (ATSSSe) rule data structure 900, including PDU Set Importance (PSI) traffic descriptor 902 therein used to indicate the importance of a PDU Set to the UEe under the multiple access conditions, as previously described. In one implementation, the PDU Set Importance data 902 is encoded according to a numeric scale (e.g., 0-15), such as in Table 1:

TABLE 1

| PDU Set | PDU Set Importance |
|---|---|
| PDU-A | 7 |
| PDU-B | 10 |
| . . . | . . . |
| PDU-F | 2 |

In accordance with 3GPP specifications, a PDU Set with the highest PDU Set Importance is indicated by 0 and the lowest PDU Set Importance is indicated by 15. However, the present disclosure contemplates different configurations, such as those indicated by future releases.

Additionally, although Table 1 shows only a single number associated with a PDU Set Importance, as provided in Note A 904 of FIG. 9, the present disclosure further contemplates use of a numerical range associated with a PDU Set Importance, as shown in Table 2:

TABLE 2

| PDU Set | PDU Set Importance |
|---|---|
| PDU-A | 5-7 |
| PDU-B | 8-10 |
| . . . | . . . |
| PDU-F | 1-3 |

In another implementation, the PDU Set Importance data 902 is encoded according to a non-numeric (e.g., fuzzy logic or similar) scale, such as in Table 3:

TABLE 3

| PDU Set | PDU Set Importance |
|---|---|
| PDU-A | High |
| PDU-B | Low |
| . . . | . . . |
| PDU-F | Medium |

In some embodiments, the PDU Set Importance data in a non-numeric scale format received in ATSSSe rules data by the user device 401 is mapped to a numerical value or numerical range in the user device 401.

Similar to the ATSSSe rules data, the N4e rules data sent by the SMFe 411 to the UPFe 409 may contain the PDU Set Importance data in any of the formats in Table 1 to Table 3. If the PDU Set Importance data in a non-numeric scale received in N4e rules data by the UPFe 409 can be mapped to a numerical value or numerical range in the UPFe 409.

Various other scaling or rating schemes may be used consistent with the methods and apparatus described herein, as will be appreciated by those of ordinary skill given the disclosure.

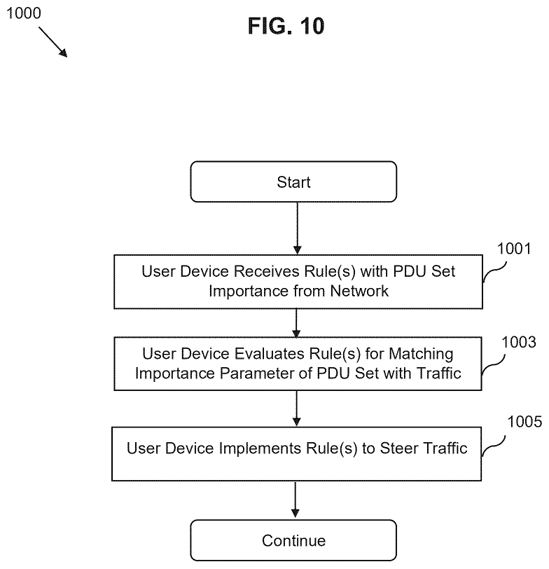

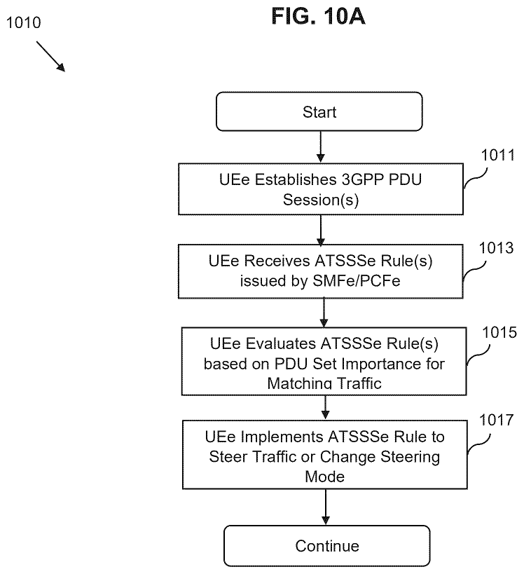

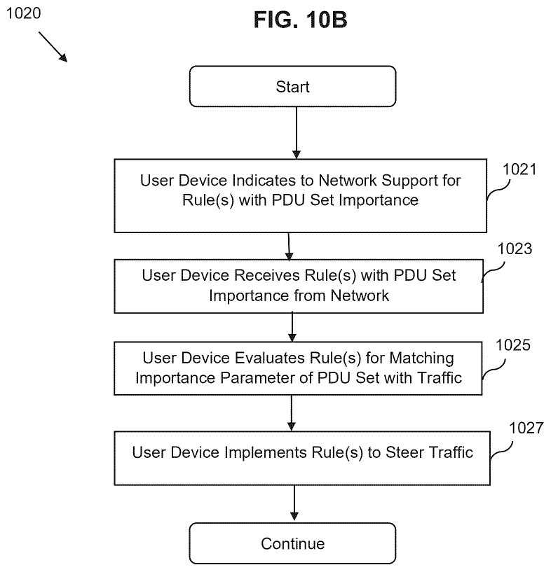

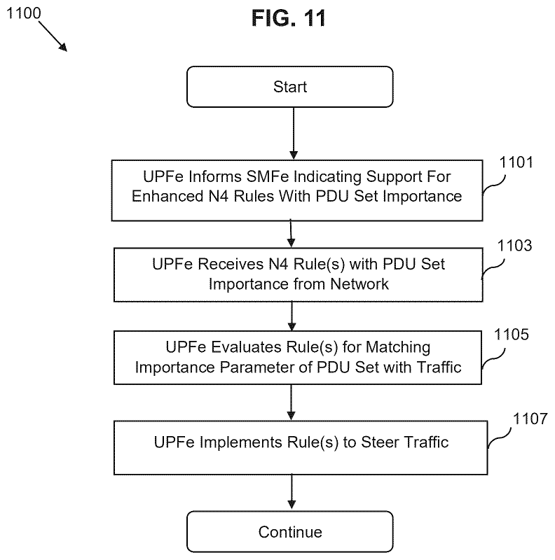

Referring now to FIGS. 10-11, exemplary methods for implementing enhanced traffic steering functionality (including e.g., 3GPP ATSSS functionality) within a wireless network are shown and described.

FIG. 10 is a logical flow diagram illustrating one embodiment of a generalized method 1000 for a user device (e.g., UEe or 5G-RG) 401 performing enhanced traffic steering according to the present disclosure. Per step 1001, the user device 401 receives from the network (e.g., the SMFe 411) enhanced rules data (e.g., the exemplary ATSSSe data structure 900 of FIG. 9) having PDU Set Importance data associated therewith. In one variant, the user device 401 receives the ATSSSe data via use of other network components with which it is associated, such as via AMF, a base station or access point.

Per step 1003, the user device 401 evaluates the rules data for matching traffic descriptions, including PDU Set Importance parameter or value(s) (e.g., which applies to the PDUs carried via the established session).

Lastly, per step 1005, the UEe 401 implements one or more rules (as reflected by the rules data, and/or others within its possession such as stored in its memory) to steer the traffic to which the rule(s) apply, such as by prioritizing the PDUs of the session(s) between 3GPP and non-3GPP accesses (see, e.g., FIGS. 4, 7, and 8 herein).

In one variant, the UEe 401 utilizes ATSSS rules received from the AMF 417 to steer, switch or split the traffic across multiple access network such as 3GPP access or non-3GPP.

FIGS. 10A and 10B are logical flow diagrams illustrating respective exemplary implementations 1010 and 1020 of the method of FIG. 10.

FIG. 10A is a logical flow diagram illustrating one implementation of the generalized method of FIG. 10, wherein a 3GPP UEe implements enhanced ATSSS steering functionality.

Per step 1011, the user device 401 establishes a data session with e.g., a distant entity such as a server. This session carries in one embodiment PDUs (protocol data units) relating to an application or process resident on the UEe, such as for voice, video, etc.

Per step 1013, the user device 401 receives ATSSSe data (e.g., the exemplary ATSSSe data structure 900 of FIG. 9) having PDU Set Importance data included therein.

This ATSSSe data having the PDU Set Importance data included therein originates from the SMFe 411, which the SMFe 411 derived from the PCCe data (PCCe rules) received from the PCFe 407.

The ATSSSe rules are received during the PDU Session establishment, and the rules can be updated at any time during the lifetime of the PDU session.

Per step 1015, the user device 401 evaluates the ATSSSe data for matching traffic descriptions (e.g., which applies to the PDUs carried via the established session). In one variant, step 1015 includes extracting the PDU Set Importance data from the ATSSSe rule, and if consistent with the PDU context (e.g., the UEe is utilizing one of the PDU Sets listed), then the steering mode and/or functions is applied per step 1017.

FIG. 10B is a logical flow diagram of another implementation of the method of FIG. 10, wherein user device 401 (e.g., UEe or 5G-RGe) can inform 5GC (e.g., SMFe 411) in messaging (e.g., the PDU Session Establishment Request signaling) whether it supports ATSSS rules enhancement with PDU Set Importance, per step 1021. Based on this information, the SMFe 411 can provide this enhanced ATSSS rule to the UE/5G-RG that supports this feature during PDU Session Establishment or Modification signaling, per step 1023. Then, per step 1025, the user device 401 evaluates the enhanced ATSSS rule, which in some variants, can include extracting the PDU Set Importance parameter(s) and determining whether the PDU Set Importance parameter of a PDU Set is matched for the uplink (UL) user data traffic received for the PDU session. If so (per step 1027), then the PDU Set Importance parameter is used as a basis for determining applicability of the steering mode and functionality data to steer the relevant traffic over one or more of the multiple accesses.

FIG. 11 is a logical flow diagram illustrating one embodiment of a generalized method 1100 for an enhanced UPF performing enhanced traffic steering according to the present disclosure. Per step 1101, the UPFe 409 informs the SMFe 411 in messaging (e.g., N4/PFCP Association Setup or N4/PFCP Association Update signaling) indicating support for enhanced N4 rules with PDU Set Importance. Based on this information, the SMFe 411 can provide this enhanced N4 rule data to the UPFe 409 that supports this feature. per 1103 during PDU Session Establishment or Modification signaling. The UPFe then evaluates the received N4e rules (or MARe) data to implement one or more steering modes or functions, per steps 1105 and 1107, respectively for the downlink (DL) user data traffic received for the PDU session.

### SMFe Apparatus—

FIG. 12 illustrates a block diagram of an exemplary embodiment of a 5G enabled enhanced SMF (SMFe) apparatus 411, useful for operation in accordance with the present disclosure.

In one exemplary embodiment as shown, the SMFe 411 includes, inter alia, a processor apparatus or subsystem 1202, a program memory module 1206, a local mass storage device 1205, and network interfaces 1223 for communications with the relevant 5G-NR RAN or other entities such as the PCFe 407 previously described herein, and the NG Core (NGC) 1225.

In one embodiment, the processor apparatus 1202 may include one or more of a digital signal processor, microprocessor, field-programmable gate array, GPU, or plurality of processing components mounted on one or more substrates. The processor apparatus 1202 may also comprise an internal cache memory. In addition, the SMFe 411 may include N4e logic 1210 and ATSSSe logic 1211 in the program memory which is in communication with the processing subsystem (as well as a 5G stack 1212 to implement other 5GS related functions of the SMFe 411). In one example, the N4e and ATSSSe logic maybe implemented as software or firmware stored on a storage device and executed on the processor 1202. In some implementations, the processor apparatus 1202 is in communication with Layer 2/3 chipset 1220 enabling the processing of layer 2/3 protocols, and the required layer 2/3 overheads in the received/transmitted data packets.

The processing subsystem 1202 is in communication with a program memory module or subsystem 1206, where the latter may include memory which may comprise, e.g., SRAM, flash and/or SDRAM (e.g., GDDR5 or GDDR6) components. The memory module 1206 may implement one or more of direct memory access (DMA) type hardware, so as to facilitate data accesses as is well known in the art. The memory module of the exemplary embodiment contains one or more computer-executable instructions that are executable by the processor apparatus 1202. A mass storage device (e.g., HDD or SSD, or NAND/NOR flash or the like) 1205 is also provided as shown.

The processor apparatus 1202 is configured to execute at least one computer program stored in memory 1206 (e.g., the logic of the N4e module and/or ATSSSe module according to the methods of FIGS. 8-8B herein, in the form of software or firmware that implements the various functions). Other embodiments may implement such functionality within dedicated hardware, logic, and/or specialized co-processors (not shown).

In some embodiments, the logic 1210 and 1211 also utilizes memory 1206 or other storage 1205 configured to temporarily and/or locally hold a number of data relating to the various rules, policies, locations, bands, and other data for the various UEe 401 which it services under the NR standard(s). In other embodiments, application program interfaces (APIs) may also reside in the internal cache or other memory 1206. Such APIs may include common network protocols or programming languages configured to enable communication between with other network entities (e.g., via API “calls” to or from the NG Core or other entities, such as MSO based headend control entities or processes, such as to implement desired frequency spectrum plans or policy changes).

As noted, the SMFe 411 includes N4e logic 1210 which is configured to derive, from the PCCe (PCCe) rules including PDU Set Importance received from the PCFe 407, N4e (or MARe) data including PDU Set Importance data, such as in cases where the Access Type Preference is “Multi-access.” It may also include ATSSSe logic 1211. N4e logic 1210 and ATSSSe logic 1211 are used to support enhanced ATTSSS rules for traffic steering behavior for UEe (or 5G-RGe) 401 and UPFe 409, respectively, as described previously herein.

### PCFe Apparatus—

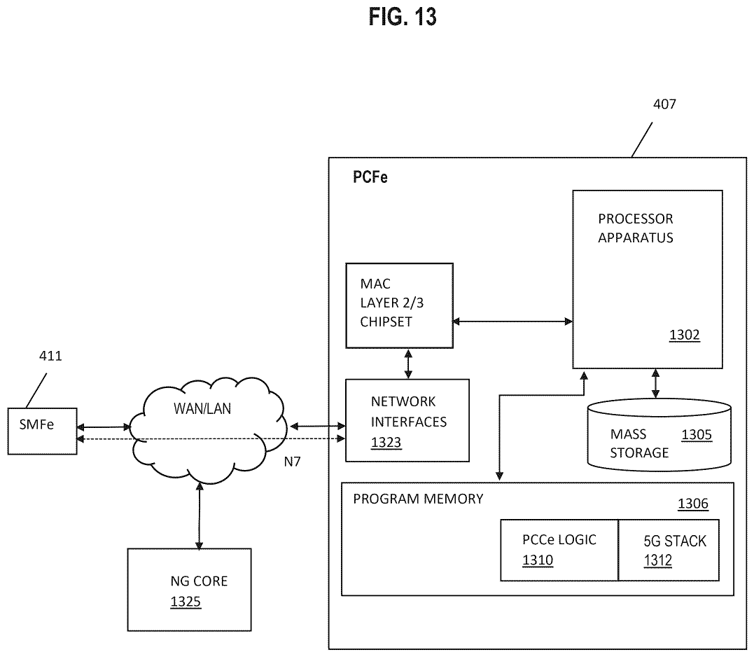

FIG. 13 illustrates a block diagram of an exemplary embodiment of a 5G enabled enhanced PCF (PCFe) apparatus 407, useful for operation in accordance with the present disclosure.

In one exemplary embodiment as shown, the PCFe 407 includes, inter alia, a processor apparatus or subsystem 1302, a program memory module 1306, a local mass storage device 1305, and network interfaces 1323 for communications with the relevant 5G-NR RAN or other entities such as the SMFe 411 previously described herein, and the NG Core (NGC) 1325.

In one embodiment, the processor apparatus 1302 may include one or more of a digital signal processor, microprocessor, field-programmable gate array, GPU, or plurality of processing components mounted on one or more substrates. The processor apparatus 1302 may also comprise an internal cache memory. In addition, the PCFe 407 may include PCCe logic 1310 in the program memory which is in communication with the processing subsystem (as well as a 5G stack 1312 to implement other 5GS related functions of the PCFe). In one example, the PCCe logic 1310 maybe implemented as software or firmware stored on a storage device and executed on the processor 1302. In some implementations, the processor apparatus 1302 is in communication with Layer 2/3 chipset 1320 enabling the processing of layer 2/3 protocols, and the required layer 2/3 overheads in the received/transmitted data packets.

The processing subsystem 1302 is in communication with a program memory module or subsystem 1306, where the latter may include memory which may comprise, e.g., SRAM, flash and/or SDRAM (e.g., GDDR5 or GDDR6) components. The memory module 1306 may implement one or more of direct memory access (DMA) type hardware, so as to facilitate data accesses as is well known in the art. The memory module of the exemplary embodiment contains one or more computer-executable instructions that are executable by the processor apparatus 1302. A mass storage device (e.g., HDD or SSD, or NAND/NOR flash or the like) 1305 is also provided as shown.

The processor apparatus 1302 is configured to execute at least one computer program stored in memory 1306 (e.g., the logic of the PCCe module according to the methods disclosed herein, in the form of software or firmware that implements the various functions). Other embodiments may implement such functionality within dedicated hardware, logic, and/or specialized co-processors (not shown).

In some embodiments, the logic 1310 also utilizes memory 1306 or other storage 1305 configured to temporarily and/or locally hold a number of data relating to the various rules, policies, locations, bands, and other data for the various UEe (or 5G-RG) 401 which it services under the NR standard(s). In other embodiments, application program interfaces (APIs) may also reside in the internal cache or other memory 1306. Such APIs may include common network protocols or programming languages configured to enable communication between with other network entities (e.g., via API “calls” to or from the NG Core or other entities, such as MSO based headend control entities or processes, such as to implement desired frequency spectrum plans or policy changes).

As noted, the PCFe 407 includes PCFe logic 1310 which is configured to support use the enhanced PCC (PCCe) rules including PDU Set Importance data, such as in cases where the Access Type Preference is “Multi-access.” It will transmit the PCCe rules including PDU Set Importance data to the SMFe 411 such that the SMF 411 can thereby generate N4e and/or ATSSSe rules data.

### UEe Apparatus—

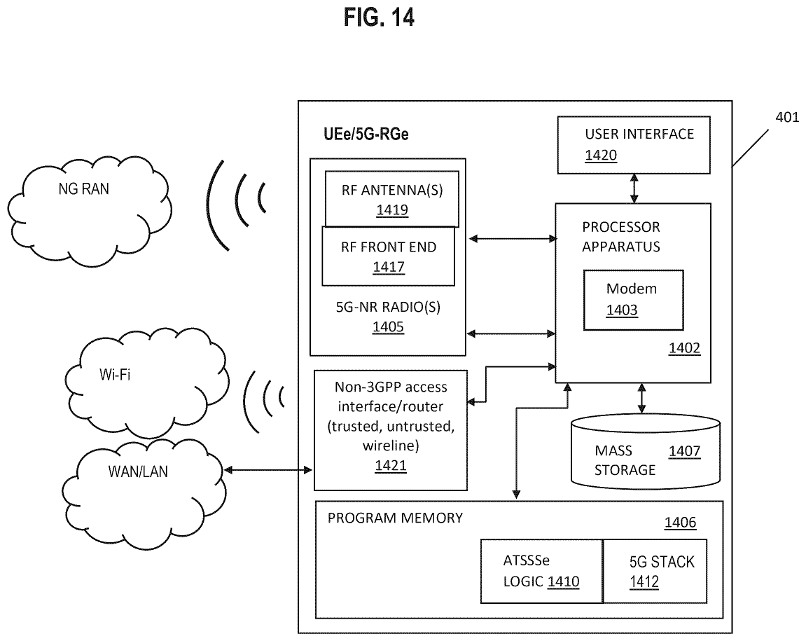

FIG. 14 illustrates a block diagram of an exemplary embodiment of an enhanced user device (UEe or 5G-RGe) apparatus 401, useful for operation in accordance with the present disclosure.

In one exemplary embodiment as shown, the enhanced user device 401 includes, inter alia, a processor apparatus or subsystem 1402, a program memory module 1406 which includes enhanced ATSSS (ATSSSe) logic 1410, as well as a 5G stack 1412 (here each implemented as software or firmware operative to execute on the processor 1402), wireless radio interface(s) 1405 for communications with the relevant RANs (e.g., 5G-NR RAN), and network interface(s) 1421 for communications with the non-3GPP access(es), which can be trusted, untrusted, and/or wireline (wireline access is applicable to the 5G-RG deployment scenario). The RF interface front ends 1417 and antenna(s) 1419 are each configured to comply with the relevant PHY standards which it supports. The antenna(s) 1419 of the UE radios may include multiple spatially diverse individual elements in e.g., a MIMO- or MISO-type configuration, such that spatial diversity of the received signals can be utilized. Moreover, a phased array or similar arrangement can be used for spatial resolution within the environment, such as based on time delays associated with signals received by respective elements.

In one embodiment, the processor apparatus 1402 may include one or more of a digital signal processor, microprocessor, field-programmable gate array, GPU, or plurality of processing components mounted on one or more substrates. The processor apparatus 1402 may also comprise an internal cache memory, and modem/baseband chipset 1403. The modem 1403 processes the baseband control and data signals for transmission and reception via the RF frond end module 1417.

As indicated, the enhanced user device 401 includes ATSSSe logic 1410 in the program memory, which is in communication with the processing subsystem, where the former may include memory which may comprise, e.g., SRAM, flash and/or SDRAM components. The memory module 1406 may implement one or more of direct memory access (DMA) type hardware, so as to facilitate data accesses as is well known in the art. The memory module of the exemplary embodiment contains one or more computer-executable instructions that are executable by the processor apparatus 1402. A mass storage device (e.g., HDD or SSD, or NAND/NOR flash or the like) is also provided as shown.

Other embodiments may implement the ATSSSe functionality within dedicated hardware, logic, and/or specialized co-processors (not shown).

As noted, the ATSSSe logic of the enhanced user device 401 is used to support enhanced ATSSS (ATSSSe) rule implementations for, inter alia, traffic steering as described herein. This may include receipt of the ATSSSe rules (such as the exemplary ATSSSe data structure 900 of FIG. 9) from the SMFe 411 (via AMF or other network components), extracting the PDU Set Importance data therefrom, and applying steering features based thereon.

In some embodiments, the enhanced user device 401 also utilizes memory 1406 or other storage 1407 configured to at least temporarily hold a number of data relating to the various network associations, band classes, ATSSSe policies and rules, and for the traffic services/applications such as voice, etc. in support of the various functions described herein. In other embodiments, application program interfaces (APIs) such as those included in an MSO-provided application or those natively available on the enhanced user device 401 may also reside in the internal cache or other memory 1406. Such APIs may include common network protocols or programming languages configured to enable communication with the enhanced user device 401 and network entities.

### UPFe Apparatus—

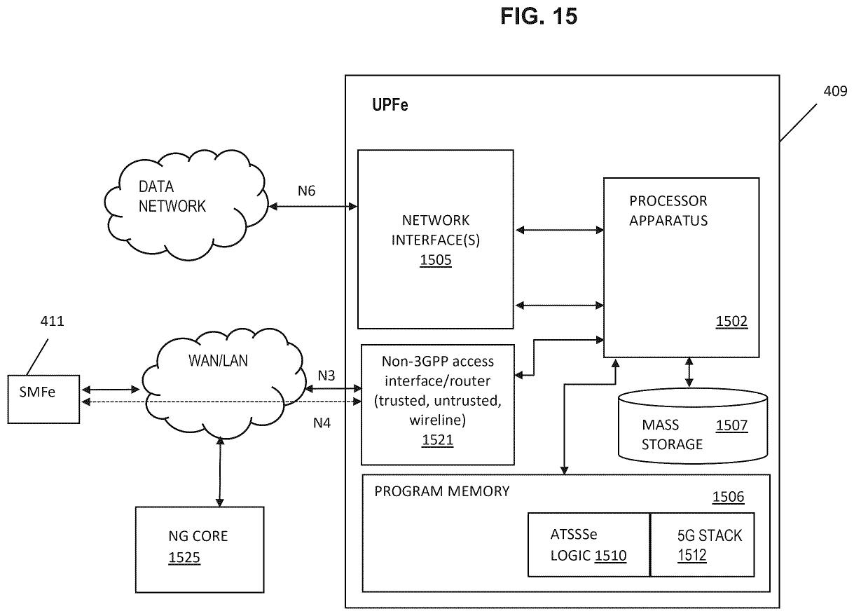

FIG. 15 illustrates a block diagram of an exemplary embodiment of an enhanced user plane function (UPFe) apparatus 409, useful for operation in accordance with the present disclosure.

In one exemplary embodiment as shown, the UPFe 409 includes, inter alia, a processor apparatus or subsystem 1502, a program memory module 1506 which includes multi access MA logic 1510, as well as a 5G stack 1512 (here each implemented as software or firmware operative to execute on the processor 1502), wireless radio interface(s) 1505 for communications with the data network (via the N6 interface), and network interface(s) 1523 and 1521 for respective communications with the 3GPP access(es) (e.g., via NG RAN) and the non-3GPP access(es) (which can be trusted, untrusted, and/or wireline access networks) via the N3 interfaces and with the SMFe 411 via the N4 interface.

In one embodiment, the processor apparatus 1502 may include one or more of a digital signal processor, microprocessor, field-programmable gate array, GPU, or plurality of processing components mounted on one or more substrates. The processor apparatus 1402 may also comprise an internal cache memory.

As indicated, the UPFe 409 includes MA logic 1510 in the program memory, which is in communication with the processing subsystem, where the former may include memory which may comprise, e.g., SRAM, flash and/or SDRAM components. The memory module 1506 may implement one or more of direct memory access (DMA) type hardware, so as to facilitate data accesses as is well known in the art. The memory module of the exemplary embodiment contains one or more computer-executable instructions that are executable by the processor apparatus 1502. A mass storage device (e.g., HDD or SSD, or NAND/NOR flash or the like) is also provided as shown.

Other embodiments may implement the MA functionality within dedicated hardware, logic, and/or specialized co-processors (not shown).

As noted, the MA logic 1510 of the UPFe is used to support enhanced N4 (including enhanced MAR) rule implementations for, inter alia, traffic steering as described herein. This may include receipt of the N4e rules and/or MARe rules (e.g., the N4e rules include the MARe rules) from the SMFe 411 (via AMF or other network components), extracting the PDU Set Importance data therefrom, and applying steering features based thereon.

In some embodiments, the UPFe 409 also utilizes memory 1506 or other storage 1507 configured to at least temporarily hold a number of data relating to the various network associations, band classes, ATSSSe policies and rules, and for the traffic services/applications such as voice, etc. in support of the various functions described herein. In other embodiments, application program interfaces (APIs) such as those included in an MSO-provided application or those natively available on the UPFe 409 may also reside in the internal cache or other memory 1506. Such APIs may include common network protocols or programming languages configured to enable communication with the UPFe 409 and network entities.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. This description is in no way meant to be limiting, but rather should be taken as illustrative of the general principles of the disclosure. The scope of the disclosure should be determined with reference to the claims.

It will be further appreciated that while certain steps and aspects of the various methods and apparatus described herein may be performed by a human being, the disclosed aspects and individual methods and apparatus are generally computerized/computer-implemented. Computerized apparatus and methods are necessary to fully implement these aspects for any number of reasons including, without limitation, commercial viability, practicality, and even feasibility (i.e., certain steps/processes simply cannot be performed by a human being in any viable fashion).

What is claimed is:

1. A method for utilizing enhanced rules data to leverage one or more steering features, the method comprising:
obtaining a first data structure, the first data structure comprising a parameter relating to an importance associated with a plurality of packet data units (PDUs);
based on at least a portion of the first data structure, determining at least one second data structure, the at least one second data structure comprising one or more steering rules with the parameter relating to the importance associated with the plurality of PDUs; and
distributing the at least one second data structure to one or more computerized devices, thereby enabling the one or more computerized devices to control one or more steering features in accordance with the one or more steering rules with the parameter relating to the importance associated with the plurality of PDUs.

2. The method of claim 1, further comprising receiving support data from the one or more computerized devices, the support data indicating that the one or more computerized devices support enhancement of the one or more steering rules with the importance associated with the plurality of PDUs.

3. The method of claim 2, wherein:
the receiving of the support data comprises a session management function (SMF) receiving, from the one or more computerized devices, the support data in PDU Session Establishment Request or Modification signaling, the support data indicating the one or more computerized devices support at least one Access Traffic Steering, Switching and Splitting (ATSSS) rules data structure including the one or more steering rules with the parameter relating to the importance associated with the plurality of PDUs;
the distributing of the at least one second data structure to the one or more computerized devices comprises distributing the at least one ATSSS rules data structure to only ones of the one or more computerized devices which support the enhancement of the one or more steering rules with the importance associated with the plurality of PDUs based on the support data; and
the one or more computerized devices comprise at least one of (i) a user equipment (UE) or (ii) a Fifth Generation Residential Gateway (5G-RG).

4. The method of claim 2, wherein:
the receiving of the support data comprises a session management function (SMF) receiving, from the one or more computerized devices, support data in at least one of (i) N4/PFCP Association Setup signaling or (ii) N4/PFCP Association Update signaling, the support data indicating the one or more computerized devices support at least one N4 rules data structure including the one or more steering rules with the parameter relating to the importance associated with the plurality of PDUs;
the distributing of the at least one second data structure to one or more computerized devices comprises distributing the at least one N4 rules data structure to only ones of the one or more computerized devices which support enhancement of the one or more steering rules with the importance associated with the plurality of PDUs based on the support data; and
the one or more computerized devices comprise one or more User Plane Functions (UPFs).

5. The method of claim 1, further comprising receiving data representative of a request for establishment of a Multi Access (MA) PDU session.

6. The method of claim 1, wherein the obtaining of the first data structure comprises a session management function (SMF) receiving, from a Policy Control Function (PCF), Policy and Charging Control (PCC) data having the parameter relating to the importance associated with the plurality of PDUs as part of one or more traffic descriptors.

7. The method of claim 6, wherein the determining of the at least one second data structure comprises generating, from the PCC data having the parameter relating to the importance associated with the plurality of PDUs as part of the one or more traffic descriptors, at least one of (i) an Access Traffic Steering, Switching and Splitting (ATSSS) rules data structure, or (ii) an N4 rules data structure, having the one or more steering rules with the parameter relating to the importance associated with the plurality of PDUs included therein.

8. The method of claim 7, wherein:
the generating of the at least one of (i) the Access Traffic Steering, Switching and Splitting (ATSSS) rules data structure, or (ii) the N4 rules data structure comprises generating at least one N4 rules data structure; and
the distributing of the at least one second data structure to the one or more computerized devices comprises transmitting the at least one N4 rules data structure to at least one User Plane Function (UPF) for controlling traffic steering, switching and splitting in a downlink direction.

9. The method of claim 7, wherein:
the generating of the at least one of (i) the Access Traffic Steering, Switching and Splitting (ATSSS) rules data structure, or (ii) the N4 rules data structure comprises generating at least one ATSSS rules data structure; and
the distributing of the at least one second data structure to the one or more computerized devices comprises transmitting the at least one ATSSS rules data structure to at least one of (a) a user equipment (UE) or (b) a Fifth Generation Residential Gateway (5G-RG) for controlling traffic steering, switching and splitting in an uplink direction.

10. The method of claim 9, wherein the transmitting of the at least one ATSSS rules data structure comprises transmitting data representative of a PDU Session Establishment Accept message having the at least one ATSSS rules data structure included therein.

11. Computerized network apparatus for use within a content distribution network, comprising:
digital processing apparatus;
at least one network interface in data communication with the digital processing apparatus; and
a storage device in data communication with the digital processing apparatus, the storage device comprising a storage medium having at least one computer program, the at least one computer program configured to, when executed on the digital processing apparatus, cause the computerized network apparatus to:
receive data relating to a request for establishment of a packet data unit (PDU) session;
cause evaluation of at least the data relating to the request for the establishment of the PDU session to obtain a data structure with an importance value or range; and
determine, from the data structure with the importance value or range, one or more rules relating to one or more steering functionalities of at least one of (i) a User Plane Function (UPF), or (ii) a computerized client device.

12. The computerized network apparatus of claim 11, wherein the causation of the evaluation of at least the data relating to the request for the establishment of the PDU session to obtain the data structure with the importance value or range comprises causation of a Policy Control Function (PCF) to evaluate at least the data relating to the request for the establishment of the PDU session to generate PCC rules data with a PDU Set Importance value or range.

13. The computerized network apparatus of claim 11, wherein the determining of the one or more rules relating to the one or more steering functionalities of the at least one of (i) the UPF, or (ii) the computerized client device comprises determining N4 rules data; and the at least one computer program is further configured to, when executed on the digital processing apparatus, cause the computerized network apparatus to:
transmit the N4 rules data to the UPF for controlling traffic steering, switching and splitting in an downlink direction.

14. The computerized network apparatus of claim 11, wherein the determining of the one or more rules relating to the one or more steering functionalities of the at least one of (i) the UPF, or (ii) the computerized client device comprises determining ATSSS rules data; and the at least one computer program is further configured to, when executed on the digital processing apparatus, cause the computerized network apparatus to:
transmit the ATSSS rules data to the computerized client device for controlling traffic steering, switching and splitting in an uplink direction.

15. A computerized wireless user apparatus for use within a wireless network, comprising:
digital processing apparatus;
at least one wireless network interface in data communication with the digital processing apparatus; and
a storage device in data communication with the digital processing apparatus, the storage device comprising a storage medium having at least one computer program, the at least one computer program configured to, when executed on the digital processing apparatus, cause the computerized wireless user apparatus to:
transmit, to a computerized network device, first data relating to a request for establishment of a packet data unit (PDU) session;
receive, from the computerized network device, second data including one or more rules and a parameter;
evaluate the one or more rules from the second data based on the parameter; and
steer traffic to the computerized network device based on the one or more rules in accordance with the parameter.

16. The computerized wireless user apparatus of claim 15, wherein the parameter comprises a parameter relating to an importance of a PDU set.

17. The computerized wireless user apparatus of claim 15, wherein the at least one computer program configured to, when executed on the digital processing apparatus, cause the computerized wireless user apparatus to:
determine whether the one or more rules are applicable to the PDU session based on wireless network configuration.

18. The computerized wireless user apparatus of claim 15, wherein the at least one computer program is further configured to, when executed on the digital processing apparatus, cause the computerized wireless user apparatus to:
indicate, in the first data relating to the request for the establishment of the packet data unit (PDU) session, support for utilization of the one or more rules with the parameter.

19. The computerized wireless user apparatus of claim 15, wherein the one or more rules comprise 3GPP ATSSS rules for the PDU session enhanced with a PDU Set Importance parameter.

20. Computer readable apparatus comprising a non-transitory storage medium, the non-transitory storage medium comprising at least one computer program having a plurality of instructions, the plurality of instructions configured to, when executed on a processing apparatus, cause a computerized network apparatus to:
receive data representative of PCC rules having data indicating a PDU Set Importance parameter as part of one or more traffic descriptors;
based on the data representative of the PCC rules, generate an enhanced ATSSS rules data structure and an enhanced N4 rules data structure, each comprising data relating to the PDU Set Importance parameter;
transmit the enhanced ATSSS rules data structure to a user device for controlling, in accordance with the PDU Set Importance parameter, traffic steering, switching and splitting in an uplink direction; and
transmit the enhanced N4 rules data structure to a User Plane Function (UPF) for controlling, in accordance with the PDU Set Importance parameter, traffic steering, switching and splitting in a downlink direction.

21. The computer readable apparatus of claim 20, wherein the computerized network apparatus comprises a session management function (SMF).

22. The computer readable apparatus of claim 20, wherein the plurality of instructions are further configured to, when executed on the processing apparatus, cause the computerized network apparatus to:
receive, from the user device, data representative of support for the enhanced ATSSS rules data structure; and
receive, from the UPF, data representative of support for the enhanced N4 rules data structure.

23. Computer readable apparatus comprising a non-transitory storage medium, the non-transitory storage medium comprising at least one computer program having a plurality of instructions, the plurality of instructions configured to, when executed on a processing apparatus, cause a User Plane Function (UPF) apparatus to:
receive enhanced N4 rules with packet data unit (PDU) set importance from a session management function (SMF), the enhanced N4 rules with the PDU Set Importance generated by the SMF based on enhanced Policy and Charging Control (PCC) rules with the PDU Set Importance received by the SMF from a Policy Control Function (PCF); and
based on the enhanced N4 rules with the PDU Set Importance, control one or more traffic steering, switching and splitting functionalities in a downlink direction.

24. The computer readable apparatus of claim 23, wherein:
the plurality of instructions are further configured to, when executed on the processing apparatus, cause the UPF apparatus to:
transmit, to the SMF and within at least one of (i) N4/PFCP Association Setup signaling or (ii) N4/PFCP Association Update signaling, data representative of support for the enhanced N4 rules with the PDU Set Importance; and
the receipt of the enhanced N4 rules with the PDU Set Importance is based on support for the enhanced N4 rules with the PDU Set Importance.

25. The computer readable apparatus of claim 23, wherein the receipt of the enhanced N4 rules with the PDU Set Importance comprises receipt of multi-access rules (MAR) with the PDU Set Importance.
